(19) United States
(12) Patent Application Publication
(10) Pub. No.: US 2024/0384204 A1
(43) Pub. Date: Nov. 21, 2024

(54) COMPOSITIONS WITH REDUCED SOLID HYDROXIDE ALKALINITY FOR EFFECTIVE REMOVAL OF PROTEIN SOILS AND ENZYME STABILITY THROUGHOUT MULTI-CYCLE DISPENSING

(71) Applicant: ECOLAB USA INC., Saint Paul, MN (US)

(72) Inventors: Victor Fuk-Pong Man, Saint Paul, MN (US); Clinton Hunt, JR., Saint Paul, MN (US); Mark Schomers, Saint Paul, MN (US); Wendy Lo, Saint Paul, MN (US)

(21) Appl. No.: 18/605,918

(22) Filed: Mar. 15, 2024

Related U.S. Application Data
(60) Provisional application No. 63/502,259, filed on May 15, 2023.
(60) Provisional application No. 63/607,875, filed on Dec. 8, 2023.

(51) Int. Cl. C11D 3/386; C11D 3/04; C11D 3/06

(52) U.S. Cl. CPC C11D 3/386; C11D 3/044; C11D 3/06

(57) ABSTRACT

Alkaline cleaning compositions using a detersive combination of surfactants, chelants and enzymes with reduced alkalinity, including between about 20-47% by percent Na₂O in the liquid or solid compositions, are disclosed. Methods of using the compositions with optimal protein removal performance that overcome limitations of reduced alkalinity content for use in cleaning, rinsing, sanitizing, and disinfecting are disclosed along with methods that stabilize enzymes for multi-cycle dispensing in solid compositions.

### CROSS REFERENCE TO RELATED APPLICATIONS

This application claims priority under 35 U.S.C. § 119 to both provisional patent applications U.S. Ser. No. 63/502,259, filed May 15, 2023, titled “COMPOSITIONS WITH REDUCED SOLID HYDROXIDE ALKALINITY FOR EFFECTIVE REMOVAL OF PROTEIN SOILS”, and U.S. Ser. No. 63/607,875, filed Dec. 8, 2023, titled “GLYCEROL CARBONATE BASED SOLID COMPOSITIONS WITH ENZYME STABILITY THROUGHOUT MULTI-CYCLE DISPENSING.” The provisional patent applications are herein incorporated by reference in their entirety, including without limitation, the specification, claims, and abstract, as well as any figures, tables, appendices, or drawings thereof.

### TECHNICAL FIELD

The present disclosure relates to the field of compositions for various alkaline cleaning applications using a detersive combination of surfactants, chelants and enzymes. Beneficially, the compositions provide optimal protein removal performance that overcome limitations of reduced alkalinity content of the compositions, including between about 20-47% by percent Na₂O in the liquid or solid compositions, for use in cleaning, rinsing, sanitizing, and disinfecting. The compositions further beneficially stabilize enzymes for multi-cycle dispensing in solid compositions.

### BACKGROUND

Alkali metal hydroxides, commonly referred to as caustic, are commonly sold in solid form (e.g. pellets, flakes, blocks) and are frequently used in manufacturing processes. The manufacturing of caustic beads is energy intensive and compositions containing caustic beads are generally hygroscopic. Additionally, there are safety concerns surrounding the transportation and handling of other strong bases, such as alkoxides. Despite challenges of using solid caustic and alkoxides there remains advantages to using solid caustic compositions. For example, storing and transporting of solid concentrates are less expensive than the storage and transporting of liquids. There are also fewer safety and stability challenges associated with transporting and handling of solid compositions.

Therefore, it is an object of the disclosure to provide alkaline compositions providing alternatives to the purchase of solid caustic to incorporate into an alkaline composition, namely solid alkaline compositions.

The use of alkali metal hydroxide compositions for various warewashing and other applications, such as bottle washing, pulp antifoaming applications, and others further requires the use of surfactants to tailor the cleaning capabilities of the caustic compositions. A particular challenge is providing desired defoaming or antifoaming in these compositions. Accordingly, it is an objective of the claimed disclosure to develop solid caustic compositions that provide highly effective defoaming and antifoaming surfactant packages while maintaining efficacy for soil removal.

It is further reported in literature that protein macromolecules maintain certain conformation or overall structure in its natural state which are dictated by secondary and tertiary structures. Denaturation disrupts the alpha helix and beta sheets in a protein and uncoil it into a random shape. The most common observation of the denaturation process is the precipitation and coagulation of the protein. Protein soil presents significant challenges in machine warewashing and CIP cleaning as they are difficult to remove and can produce stable foams.

Accordingly, it is an objective to develop compositions with detersive combinations of surfactants, chelants and enzymes that can partially denature proteins and provide required defoaming to avoid cavitation in pumping mechanical action. It is desired to provide antifoaming or defoaming surfactant to be surface active enough to penetrate protein stabilized foam lamellae, partially denature the protein to a certain degree to produce proper defoaming, yet without full denaturation to cause precipitation/coagulation of the protein to cause deposition problem.

Other objects, advantages and features of the present disclosure will become apparent from the following specification taken in conjunction with the accompanying drawings.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

According to embodiments compositions comprise: alkalinity source comprising an alkali metal hydroxide, alkali metal carbonate and/or reagents comprising an organic molecule having at least one hydroxyl group or an alkylene carbonate; a first surfactant comprising a first reverse EO/PO block copolymer of about 10-40% EO; and an optional second surfactant comprising at least one of a second reverse EO/PO block copolymer of about 40-50% EO, an alkyl capped alcohol ethoxylate, a capped block copolymer, and alkyl pyrrolidone; a strong chelating agent having a stability constant with calcium that is at least about 1×10⁷; and a protease enzyme, wherein the composition is a liquid or solid and has between from about 20-47%, from about 25-40%, or preferably from about 28-37% total alkalinity as measured by percent Na₂O in the composition.

According to additional embodiments methods of generating a use solution of the compositions described herein comprise: contacting an article or surface in need of soil removal with the use solution; and cleaning to remove the soil from the article or surface, wherein the soil comprises protein.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

FIG. 1 shows a graph of enzymatic activity evaluated in dispensing run off testing as described in Example 2.

FIG. 2 shows an image of ceramic tiles treated with Composition 8 compared to Control after a 10-Cycle machine warewash experiment as described in Example 3.

FIG. 3 shows an image of ceramic tiles treated with Composition 8 compared to Control after a 10-Cycle machine warewash experiment as described in Example 3.

FIG. 4 shows an image of glassware treated with Composition 8 compared to Control demonstrating both enzyme stability and the improved performance as described in Example 4.

FIG. 5 shows a graph of enzymatic activity evaluated in dispensing run off testing as described in Example 5.

Various embodiments will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION

The embodiments of this disclosure are not limited to particular compositions, methods of making and/or methods of employing the same, which can vary and are understood by skilled artisans. So that the disclosure may be more readily understood, certain terms are first defined. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, humidity, molar ratios, log count of bacteria or viruses, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkoxide” refers to a conjugate base of an organic molecule having one or more hydroxyl groups and can be formed through the deprontonation of the hydroxyl group(s), which is a weak acid/base reaction. Alkoxides can be formed through the reaction of an alkali metal hydroxide and an organic molecule having one or more hydroxyl-groups or an alkylene carbonate as disclosed in U.S. Patent Application No.______, claiming priority to U.S. Ser. No. 63/490,838, filed simultaneously herewith and titled “Alkoxide-Based Solidification Via Control of Reaction Equilibrium and Kinetics”, which is incorporated by reference in its entirety.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “analog” means a molecular derivative of a molecule. The term is synonymous with the terms “structural analog” or “chemical analog.”

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). According to this reference a disinfectant should provide a 99.999% reduction (5-log order reduction) within 30 seconds at room temperature, 25±2° C., against several test organisms. According to embodiments of the disclosure, a disinfecting composition provides a 99.999% reduction (5-log order reduction) of the desired organisms (including bacterial contaminants) at a use temperature. Further, a disinfectant should provide a 99.99% reduction (4-log order reduction) within 30 seconds at room temperature, 25±2° C., against several test organisms. According to embodiments of the disclosure, a disinfecting composition provides a 99.99% reduction (4-log order reduction) of the desired organisms (including bacterial contaminants) at a use temperature. Further, a disinfectant should provide a 99.9% reduction (3-log order reduction) within 30 seconds at room temperature, 25±2° C., against several test organisms. According to embodiments of the disclosure, a disinfecting composition provides a 99.9% reduction (3-log order reduction) of the desired organisms (including bacterial contaminants) at a use temperature. As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “generally” encompasses both “about” and “substantially.”

The term “hard surface” refers to a solid, substantially non-flexible surface such as a countertop, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “oligomer” refers to a molecular complex comprised of between one and ten monomeric units. For example, dimers, trimers, and tetramers, are considered oligomers. Furthermore, unless otherwise specifically limited, the term “oligomer” shall include all possible isomeric configurations of the molecule, including, but are not limited to isotactic, syndiotactic and random symmetries, and combinations thereof. Furthermore, unless otherwise specifically limited, the term “oligomer” shall include all possible geometrical configurations of the molecule.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “soft surface” refers to surfaces not classified as hard surfaces, but which are solid surfaces. Soft surfaces, include, but are not limited to, textiles, fabrics, woven surfaces, and non-woven surfaces. Soft surfaces, include, but are not limited to, carpet, curtains, fabrics, hospital partitions, linens, and upholstery.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET).

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The solid compositions, methods of making the compositions, and methods of use of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Compositions

The compositions employing detersive combinations of surfactants, chelants and enzymes with alkalinity as described herein comprise an alkalinity source, a combination of surfactants including a first surfactant comprising a first reverse EO/PO block copolymer, preferably a reverse EO/PO block copolymer of about 10-40% EO, most preferably a reverse EO/PO block copolymer of about 20% EO, and a second surfactant comprising at least one of a second reverse EO/PO block copolymer of about 40-50% EO, an alkyl capped alcohol ethoxylate, a capped block copolymer, and alkyl pyrrolidone, for protein soil removal, a strong chelating agent, and a protease enzyme. The compositions can be solid or liquid. In aspects, solid compositions are preferred as the compositions overcome limitations in the art of providing stable alkaline solids that do not require use of sodium hydroxide beads. In embodiments the solid compositions can further comprise at least one additional functional ingredient, such as a water conditioning agent, e.g. water conditioning polymers and/or hydrotrope.

Exemplary ranges of the compositions according to the disclosure are shown in Tables 1A-1B each in weight percentage. Exemplary ranges of the reagents to make the solid compositions are shown in Table IC where the simplified term “polyol” is used, however also includes the scope of the broader description contained herein of organic molecules having at least one hydroxyl group (i.e. includes polyols). While the components may have a percent actives of 100%, it is noted that Tables 1A-1D do not recite the percent actives of the components, but rather, recites the total weight percentage of the raw materials (i.e. active concentration plus inert ingredients).

TABLE 1A

| | First | Second | Third |
|---|---|---|---|
| | Exem- | Exem- | Exem- |
| | plary | plary | plary |
| | Range | Range | Range |
| Material | wt.-% | wt.-% | wt.-% |
| First Surfactant | 0.1-5 | 0.5-5 | 1-5 |
| [Reverse EO/PO block copolymer of | | | |
| about 10-40% EO] | | | |
| Second Surfactant(s) | 0.1-20 | 1-20 | 1-10 |
| [at least one of a second reverse EO/PO | | | |
| block copolymer of about 40-50% EO, an | | | |
| alkyl capped alcohol ethoxylate, a capped | | | |
| block copolymer, and alkyl pyrrolidone] | | | |
| Alkalinity source(s) | 20-80 | 25-80 | 30-80 |
| Chelant | 1-20 | 2-15 | 2-15 |
| Enzyme | 0.1-10 | 1-10 | 1-5 |
| Additional Functional Ingredients | 0-50 | 0-30 | 0-25 |
| Total | 100 | 100 | 100 |

TABLE 1B

| | First | Second | Third |
|---|---|---|---|
| | Exem- | Exem- | Exem- |
| | plary | plary | plary |
| | Range | Range | Range |
| Material | wt.-% | wt.-% | wt.-% |
| First Surfactant | 0.1-5 | 0.5-5 | 1-5 |
| [Reverse EO/PO block copolymer of | | | |
| about 10-40% EO] | | | |
| Second Surfactant(s) | 0.1-20 | 1-20 | 1-10 |
| [at least one of a second reverse EO/PO | | | |
| block copolymer of about 40-50% EO, an | | | |
| alkyl capped alcohol ethoxylate, a capped | | | |
| block copolymer, and alkyl pyrrolidone] | | | |
| Alkalinity source(s) | 20-80 | 25-80 | 30-80 |
| Chelant | 1-20 | 2-15 | 2-15 |
| Enzyme | 0.1-10 | 1-10 | 1-5 |
| Additional Functional Ingredients | 0-50 | 0-30 | 0-25 |
| Total | 100 | 100 | 100 |

TABLE 1C

| | First | Second | Third |
|---|---|---|---|
| | Exem- | Exem- | Exem- |
| | plary | plary | plary |
| | Range | Range | Range |
| Material | wt.-% | wt.-% | wt.-% |
| First Surfactant | 0.1-5 | 0.5-5 | 1-5 |
| [Reverse EO/PO block copolymer of | | | |
| about 10-40% EO] | | | |
| Optional Second Surfactant(s) | 0-20 | 0-20 | 0-10 |
| [at least one of a second reverse EO/PO | | | |
| block copolymer of about 40-50% EO, an | | | |
| alkyl capped alcohol ethoxylate, a capped | | | |
| block copolymer, and alkyl pyrrolidone] | | | |
| Alkalinity source(s) | 20-80 | 25-80 | 30-80 |
| Chelant | 1-20 | 2-15 | 2-15 |
| Enzyme | 0.1-10 | 1-10 | 1-5 |
| Additional Functional Ingredients | 0-50 | 0-30 | 0-25 |
| Total | 100 | 100 | 100 |

TABLE 1D

| | First | Second | Third |
|---|---|---|---|
| | Exem- | Exem- | Exem- |
| | plary | plary | plary |
| | Range | Range | Range |
| Material | wt.-% | wt.-% | wt.-% |
| First Surfactant | 0.1-5 | 0.5-5 | 1-5 |
| [Reverse EO/PO block copolymer of | | | |
| about 10-40% EO] | | | |
| Second Surfactant(s) | 0.1-20 | 1-20 | 1-10 |
| [at least one of a second reverse EO/PO | | | |
| block copolymer of about 40-50% EO, an | | | |
| alkyl capped alcohol ethoxylate, a capped | | | |
| block copolymer, and alkyl pyrrolidone] | | | |
| Alkali metal hydroxide | 20-80 | 25-80 | 30-80 |

Polyol or Alkylene Carbonate

| | | | |
|---|---|---|---|
| Polyol | 1-20 | 1-15 | 1-10 |
| Alkylene Carbonate | 1-40 | 1-20 | 5-20 |
| Chelant | 1-20 | 2-15 | 2-15 |
| Enzyme | 0.1-10 | 1-10 | 1-5 |
| Additional Functional Ingredients | 0-50 | 0-30 | 0-25 |
| Total | 100 | 100 | 100 |

### Reverse EO/PO Block Copolymer

Reverse EO/PO block copolymers are included in the compositions as disclosed herein. A “reverse” EO/PO block copolymer structure has EO groups on the inside and the PO groups are on the outside, (PO)_{Y} (EO)_{X} (PO)_{Y} wherein EO represents an ethylene oxide group, PO represents a propylene oxide group, and X and Y reflect the average molecular proportion of each alkylene oxide monomer in the overall block copolymer composition. The reverse EO/PO block copolymer surfactants can be linear or branched.

Typical reverse block copolymers useful as defoamers have ethoxylation up to about 20% and those useful as wetting agents have ethoxylation between about 20% and 40%. Additionally, reverse block copolymers due not usually exhibit both good wetting and defoaming properties, instead they are typically selected for one or the other based on the degree of ethoxylation.

In embodiments, the degree of ethoxylation of the first reverse EO/PO block copolymers included as a first surfactant for protein soil defoaming is about 10-40%, about 20-40%, most preferably about 20%. In embodiments of the first surfactant, the propoxylation of the first reverse EO/PO block copolymers is about 60-90%, about 60-80%, most preferably about 80%. In addition, without being limited according to the disclosure, all ranges recited are inclusive of the numbers defining the range and include each integer within the defined range. Commercially available examples of the reverse EO/PO block copolymers included as a first surfactant for protein soil defoaming include for example PLURONIC 25R2 and SURFONIC LD-097.

In a preferred embodiment the first surfactant is a reverse EO/PO block copolymer of about 20-40% EO. In a further preferred embodiment the first surfactant is a reverse EO/PO block copolymer having about 20% EO/80% PO regardless of the number of arms in the surfactant structure.

In an embodiment, the ethoxylation of the reverse EO/PO block copolymers included as a second surfactant for protein soil cleaning (i.e. removal) is about 40-50% and can have a linear or branched (i.e. arms) structure. In embodiments of the second surfactant, the propoxylation of the reverse EO/PO block copolymers is about 50-60%. In addition, without being limited according to the disclosure, all ranges recited are inclusive of the numbers defining the range and include each integer within the defined range. Commercially available examples of the EO/PO block copolymers included as a second surfactant for protein soil removal include for example TETRONIC 90R4.

In a preferred embodiment the second surfactant is a reverse EO/PO block copolymer having about 40% EO/60% PO.

According to various embodiments the reverse EO/PO block copolymer(s) included are included in an amount of about 0.1 wt-% to about 50 wt-%, about 0.5 wt-% to about 20 wt-%, or about 0.5 wt-% to about 2 wt-%.

According to various embodiments of the compositions, the reverse EO/PO block copolymers is included as a first surfactant for protein soil defoaming in an amount of about 0.1 wt-% to about 10 wt-%, about 0.1 wt-% to about 5 wt-%, about 0.5 wt-% to about 5 wt-%, or about 0.5 wt-% to about 2 wt-%.

According to various embodiments of the compositions, the reverse EO/PO block copolymers is included as a second surfactant for protein soil cleaning in an amount of about 0 wt-% to about 15 wt-%, about 0.5 wt-% to about 15 wt-%, about 1 wt-% to about 10 wt-%, or about 2 wt-% to about 10 wt-%.

### Alkyl Capped Alcohol Ethoxylate

Alkyl capped alcohol ethoxylates can be included in compositions as disclosed herein. Alkyl capped alcohol ethoxylate compounds have the following structure: R₁—O—(CH₂CH₂O)ₙ—R₂ where R₁ is a linear or branched (C₁₀-C₁₈) alkyl group, R₂ is C₁-C₄, and n is an integer in the range of 1 to 100.

In preferred embodiments the alkyl capped alcohol ethoxylate is a butyl capped alcohol ethoxylate, such as for example a lauryl fatty alcohol ethoxylate butyl ether or coconut fatty alcohol ethoxylate butyl ether.

Commercially available examples of the alkyl capped alcohol ethoxylates included as a second surfactant for protein soil removal include for example surfactants sold under the tradename DEHYPON LT or GENAPOL BE-2810 and GENAPOL BE-2410.

According to various embodiments of the compositions, the alkyl capped alcohol ethoxylate is included as a second surfactant for protein soil defoaming in an amount of about 0 wt-% to about 10 wt-%, about 0.1 wt-% to about 10 wt-%, about 0.1 wt-% to about 5 wt-%, about 0.5 wt-% to about 5 wt-%, or about 0.5 wt-% to about 2 wt-%.

### Alkyl Pyrrolidone

An alkyl pyrrolidone surfactant can be included in compositions as a second surfactant for protein soil removal as disclosed herein. Pyrrolidones are heterocyclic ketones derived from a pyrrolidone. Alkyl pyrrolidones have the general structure

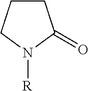

wherein R is a C6-C20 alkyl or R₁NHCOR₂, wherein R₁ is C1-C6 alkyl and R₂ is C6-C20 alkyl.

In embodiments the alkyl pyrrolidone has the general structure shown above wherein R is C8-C10 alkyl pyrrolidone. In preferred embodiments the alkyl pyrrolidone is a C8 or C10 alkyl pyrrolidone. An example of a commercially available C8 alkyl pyrrolidone (1-octyl-2-pyrrolidone) and a C12 alkyl pyrrolidone are available under the tradename SURFADONE®.

According to various embodiments of the solid compositions, the alkyl pyrrolidone is included as a second surfactant for protein soil cleaning in an amount of about 0 wt-% to about 15 wt-%, about 0.5 wt-% to about 15 wt-%, about 1 wt-% to about 10 wt-%, or about 2 wt-% to about 10 wt-%.

### Capped Block Copolymers

Capped block copolymers can be included in the surfactant compositions and/or the solid compositions as disclosed herein. Capped block copolymers are disclosed in U.S. Patent Application No.______, claiming priority to U.S. Ser. No. 63/490,857, filed simultaneously herewith and titled “Capped Block Copolymers, Their Synthesis, Manufacture, and Methods of Use”, which is incorporated by reference in its entirety.

Preferably, the capped block copolymers are multiarmed. Preferred block copolymers may have from about 1 to about 100 moles of EO and from about 1 to about 100 moles of PO, more preferably from about 1 to about 50 moles EO and from about 1 to about 50 moles PO. Some examples of block copolymers include:

-(PO)_{Y}(EO)_{X} -(EO)_{X}(PO)_{Y} -(EO)_{X}(PO)_{Y}(EO)_{X} -(PO)_{Y}(EO)_{X}(PO)_{Y}

wherein EO represents an ethylene oxide group, PO represents a propylene oxide group, and X and Y reflect the average molecular proportion of each alkylene oxide monomer in the overall block copolymer composition. A preferred EO/PO copolymer is represented by the formula (EO)_{X}(PO)_{Y} (EO)_{X}. In another embodiment, a preferred EO/PO copolymer is represented by the formula (PO)_{Y} (EO)_{X} (PO)_{Y}. Preferably X is in the range of about 1 to about 100 and Y is in the range of about 1 to about 100. In a more preferred embodiment, X is in the range of about 5 to about 90 and Y is in the range of about 5 to about 90. Preferably, X plus Y is in the range of about 2 to about 200, more preferably about 10 to about 180, still more preferably about 15 to about 150. It should be understood that each X and Y in a molecule can be different. In a preferred embodiment, the block copolymer can have a molecular weight (Mn-number average mw) greater than about 200 and less than about 25,000, more preferably from about 500 to about 25,000, most preferably from about 1000 to about 20,000.

In embodiments the capped block copolymers provide the advantage of exhibiting good wetting and defoaming properties; this is highly beneficial as there is typically a trade-off in these properties such that high defoaming properties may come at the expense of wetting properties and high wetting properties may come at the expense of defoaming properties. A preferred embodiment for the capped block copolymer comprises a multiarm block copolymer comprising a polyfunctional moiety and at least 2 alkoxylated arms each of which is selected from the group consisting of -(PO)_{Y}(EO)_{X}, -(EO)_{X}(PO)_{Y}, -(EO)_{X}(PO)_{Y}(EO)_{X}, and -(PO)_{Y}(EO)_{X}(PO)_{Y}; wherein X is about 1 to about 100, and Y is about 1 to about 100; wherein each of the alkxoylated arms comprises a terminus and is capped with a hydrophobic group at the terminus.

These EO/PO block copolymers can include a compact alcohol EO/PO surfactant where the EO and PO groups are in small block form, or random form. In other embodiments, the alkyl alkoxylate includes an ethylene oxide, a propylene oxide, a butylene oxide, a pentalene oxide, a hexylene oxide, a heptalene oxide, an octalene oxide, a nonalene oxide, a decylene oxide, and mixtures thereof. The alkyl group can be linear or branched and is preferably C₁-C₁₈, more preferably C₁₀-C₁₈; most preferably it is a branched alkyl group. Exemplary commercially available surfactants are available, for example, under the tradename PLURONIC® and PLURONIC R®, TETRONIC®, and SURFONIC®.

In a preferred embodiment, the block copolymer comprises a linear or multiarmed EO/PO structures. Most preferably, the block copolymer is a “reverse” block copolymer with the EO inside and the PO on the terminal end. Non-limiting examples are shown below:

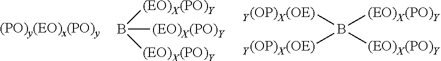

where B is an organic molecule with a polyfunctional moieties, such as a polyol, ethylene diamine, or diethylenetriamine, etc, as the starting point where the arms attach. It should be understood that these are not representative of the orientations of the arms, but merely representative of the potential formulations for purposes of illustrating the attachment of the alkoxylated arms to the starting polyfunctional moiety. Further, X and Y are defined further below where the degree of ethoxylation and propoxylation are discussed.

The capped block copolymers disclosed herein include what is often referred to as a “reverse” structure, that is, the EO groups are on the inside and the PO groups are on the outside, (PO)_{Y} (EO)_{X} (PO)_{Y}. Typical reverse block copolymers useful as defoamers have ethoxylation up to about 20% and those useful as wetting agents have ethoxylation between about 20% and 40%. However, typical reverse block copolymers for defoamer or wetting are not capped. Additionally, reverse block copolymers due not usually exhibit both good wetting and defoaming properties, instead they are typically selected for one or the other based on the degree of ethoxylation.

Preferably the ethoxylation is greater than about 20%, more preferably greater than about 20% and up to about 60%, still more preferably from about 25% to about 55%, even more preferably from about 30% to about 50%, still more preferably from about 35% to about 45%, most preferably about 40%.

Preferably the propoxylation is less than about 80%, more preferably from about 40% to less than about 80%, still more preferably from about 45% to about 75%, even more preferably from about 50% to about 70%, still more preferably from about 55% to about 65%, most preferably about 60%.

As used herein “arm(s)” refers to the alkoxylated chains; thus a multiarmed capped block copolymer would have more than one alkoxylated chain. The capped block copolymers preferably are multiarmed having at least 2 arms, more preferably at least 3 arms, even more preferably 3-6 arms, still more preferably 4 or 5 arms, and most preferred 4 arms. Preferably, the arms are formed by a branched alkyl group (backbone), which the block copolymer arms attach to. Non-limiting examples of 2 arms, 3 arms, and 4 arms are shown below for illustrative purposes:

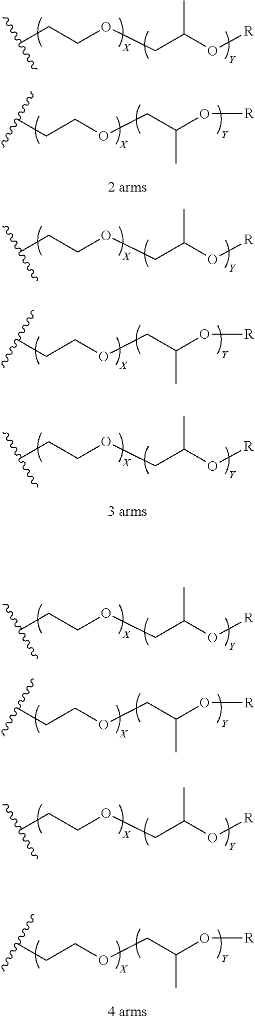

where R is a hydrophobic capping group as disclosed herein, X and Y are as defined above, each preferably between 1 and 100; and the EO/PO arms would be attached to a single backbone such that a single molecule is formed with at least 2 alkoxylated arms, at least 3 alkoxylated arms, at least 4 alkoxylated arms, at least 5 alkoxylated arms, or at least 6 alkoxylated arms. It should be understood that the block copolymer can have arms of different degrees of ethoxylation and/or propoxylation. Additionally, different arms of the block copolymer can have different hydrophobic capping groups at the terminus of each.

It should be understood that the number of arms, nature of the alkyl backbone, and percentages of ethoxylation and propoxylation on the arms can be determined by using a preexisting block copolymer surfactant and capping it according to the methods disclosed herein.

The multi-arm capped, reverse block copolymers are capped, i.e., the terminus of each arm is capped with a capping chemistry. Preferred capping chemistries are hydrophobic groups. More preferably, the hydrophobic group comprises a benzyl group and/or a substituted silyl group (R₁R₂R₃Si—) shown below:

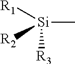

where each of R₁, R₂, and R₃ comprises an alkyl group, a phenol group, or tert-butyl.

Preferred alkyl groups for R1, R2, and/or R3 include straight-chain alkyl groups having between 1 and 10 carbons (i.e., methyl, ethyl, propyl, butyl, pentyl, hexyl, heptyl, octyl, nonyl, and decyl); cyclic alkyl groups (or “cycloalkyl” or “alicyclic” or “carbocyclic” groups), including, but not limited to, cyclopropyl, cyclopentyl, cyclohexyl, cycloheptyl, cyclooctyl, cyclononyl, and cyclodecyl; branched-chain alkyl groups, including, but not limited to isopropyl, tert-butyl, sec-butyl, isobutyl; and alkyl-substituted alkyl groups, including but not limited to, alkyl-substituted cycloalkyl groups and cycloalkyl-substituted alkyl groups.

More preferably the hydrophobic group comprises a benzyl group, trimethylsilyl (TMS), triethylsilyl (TES), tert-butyldimethylsilyl (TBS), tert-butyldiphenylsilyl (TBDPS), triisopropylsilyl (TIPS), or a combination thereof. These preferred silyl-based capping chemistries are shown below:

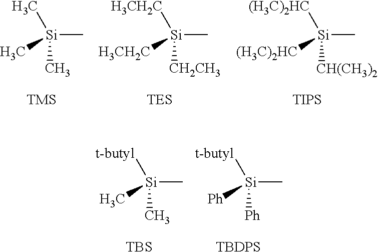

In the instance where there is a combination of hydrophobic groups utilized, this is due to capping of the different arms (e.g., two arms capped with TIPS and two arms capped with a benzyl group). Most preferably the hydrophobic group comprises a benzyl group, trimethylsilyl (TMS), triisopropylsilyl (TIPS), or a combination thereof.

In an embodiment where the block copolymer has two arms, one or both arms can be capped. In an embodiment where the block copolymer has three arms, one, two or three arms can be capped. In an embodiment where the block copolymer has four arms, one, two, three or four arms can be capped. In an embodiment where the block copolymer has five arms, one, two, three, four or five arms can be capped. In an embodiment where the block copolymer has six arms, one, two, three, four, five, or six arms can be capped.

The ratio of capped to uncapped arms can impact the thermal stability of the capped block copolymers. Thermal stability is increased with increased capping; thus, it is preferred to have a ratio of at least greater than 1:1 for capped to uncapped arms, most preferably all arms being capped for high temperature use applications. Thus, in applications requiring thermal stability it is preferable to have at least two of three arms capped, at least three of four arms capped, at least four of five arms capped, at least four of six arms capped, at least five of six arms capped, most preferably all arms capped.

Retaining some uncapped arms improves viscoelasticity of the capped block copolymers. Most preferably we found that a ratio of about 2:1 to about 4:1 capped to uncapped arms; most preferably about 3:1 capped to uncapped arms. Thus, in applications where viscoelasticity is desired, two of three arms are capped, three of four arms are capped, three of five arms are capped, four of five arms are capped, four of six arms are capped, five of six arms are capped.

Beneficially, the capped block copolymers disclosed herein have a low surface tension. Preferably a surface tension of less than about 35 dynes/cm, more preferably less than about 34 dynes/cm, still more preferably less than about 33 dynes/cm, even more preferably less than about 32 dynes/cm, yet more preferably less than about 31 dynes/cm, still more preferably less than about 30 dynes, even more preferably less than about 29 dynes, yet more preferably less than about 28 dynes/cm, still more preferably less than about 27 dynes/cm, even more preferably less than about 26 dynes/cm, yet more preferably less than about 25 dynes/cm, still more preferably less than about 24 dynes, even more preferably less than about 23 dynes, yet more preferably less than about 22 dynes/cm, still more preferably less than about 21 dynes, most preferably about 20 dynes/cm or less; when tested under ambient temperature and humidity.

As discussed above, the problems associated with proteinaceous soils are well known and particularly problematic for machine warewash and CIP cleaning. Without wishing to be bound by the theory, we believe for optimal performance, a defoaming surfactant should be surface active enough to penetrate protein stabilized foam lamellae, partially denature the protein to a certain degree to produce proper defoaming, yet without full denaturation to cause precipitation/coagulation of the protein to cause deposition problem.

According to various embodiments of the compositions, the capped block copolymers are included as a second surfactant in an amount of about 0 wt-% to about 15 wt-%, about 0.5 wt-% to about 15 wt-%, about 1 wt-% to about 10 wt-%, or about 2 wt-% to about 10 wt-%.

### Alkalinity Source

In embodiments, the compositions contain at least one alkalinity source. Alkalinity sources can include alkali metal hydroxides, alkali metal carbonates, and/or reagents combined to form an alkoxide solid, including alkali metal hydroxide and reagents comprising an organic molecule having at least one hydroxyl group or an alkylene carbonate. Embodiments as described herein do not require the formation of alkoxide solids from the reagents. In some embodiments the primary alkalinity source can include an alkali metal carbonate with substantially less alkali metal hydroxide while also including an organic molecule having at least one hydroxyl group or an alkylene carbonate, wherein the hydroxide does not form an alkoxide with the organic molecule having at least one hydroxyl group or the alkylene carbonate.

Alkalinity sources can include an effective amount of one or more alkalinity sources. An effective amount of one or more alkaline sources should be considered as an amount that provides a composition having a pH between about 7 and about 14. In a particular embodiment the end-use compositions can have a pH of between about 7.5 and about 12.5.

In embodiments the alkalinity source in the final composition (including alkalinity and/or neutralization from additional components in the composition) provides a total alkalinity as measured by percentage of Na₂O is from about 20-47%, from about 25-40%, or preferably from about 28-37%. In embodiments the total alkalinity as measured by percentage of Na₂O is from about 20-47%, from about 25-40%, or preferably from about 28-37%, has more alkalinity provided by carbonate alkalinity source compared to caustic alkalinity source. Total alkalinity can measure alkalinity from various sources in addition to sodium hydroxide, including less alkalinity sources such as, for example, sodium bicarbonate. The total alkalinity is measured by standard acid-based titration using HCl in a liquid or in a solid dissolved in water to generate a liquid.

In embodiments the alkalinity source in the final composition is less than about 70:30 alkali metal hydroxide to water weight ratio to provide improved cleaning performance in comparison to compositions comprising additional alkali metal hydroxide.

### Alkali Metal Carbonate

In embodiments, the compositions can contain at least one alkali metal carbonate. In an embodiment of the disclosure, any suitable source of carbonate may be used. In an embodiment, an alkali metal carbonate source may be used, for example, sodium carbonate, potassium carbonate, lithium carbonate, and combinations thereof.

The alkali metal carbonate can be in the compositions in an amount of about 1 wt-% to about 99.9 wt-%, about 10 wt-% to about 90 wt-%, about 20 wt-% to about 90 wt-%, about 30 wt-% to about 90 wt-%, about 30 wt-% to about 80 wt-%, about 40 wt-% to about 85 wt-%, or about 30 wt-% to about 70 wt-%.

### Alkali Metal Hydroxide

In embodiments, the compositions contain at least one alkali metal hydroxide as a caustic source. As referred to herein, caustic is synonymous with hydroxide. While not wishing to be bound by a particular theory or mechanism of action, it is believed that the caustic plays a role in partially denaturing proteinaceous soils to aid in their removal and is thus particularly suitable to cleaning compositions used to clean soils comprising proteinaceous soils.

In an embodiment of the disclosure, any suitable source of caustic may be used. In an embodiment, an alkali metal caustic source may be used. For example, caustic sources may be in the form of sodium hydroxide, potassium hydroxide, lithium hydroxide, derivatives thereof, or and combinations thereof. An example of a derivative of a caustic source is a preformed alkoxide.

In the methods of making the solid composition the alkali metal hydroxide is a solution or a liquid alkali metal hydroxide. In further embodiments additional caustic source can be included in the form of a solid, such as caustic beads, pellets, flakes, powder, granules, and the like may be combined with the liquid alkali metal hydroxide.

In embodiments of the solid compositions an alkali metal hydroxide is reacted with an organic molecule having one or more hydroxyl-groups or an alkylene carbonate as disclosed in U.S. Patent Application No. 63/490,838, claiming priority to U.S. Ser. No. 63/490,838, filed simultaneously herewith and titled “Alkoxide-Based Solidification Via Control of Reaction Equilibrium and Kinetics”, which is incorporated by reference in its entirety.

In an embodiment a higher active caustic liquid is preferred for the control of equilibrium reaction and kinetics for the generation of solid compositions. In an embodiment, the molar ratio of caustic to reagent (e.g. propylene glycol) is about 1:1 to about 10:1 molar ratio, about 1:1 to about 8:1 molar ratio, about 1:1 to about 6:1 molar ratio, and preferably about 1:1. In exemplary embodiments of the Examples, the reaction of glycol reagents is faster to produce the compositions, namely solid compositions.

In an embodiment, a concentrated caustic can be used in the methods of making the compositions, namely solid compositions. In an embodiment, 70% NaOH is preferred over a 50% NaOH to provide the 1:1 (or greater) molar ratio of caustic to reagent. In preferred embodiments, a concentrated alkali metal hydroxide comprises greater than 50% (actives basis) liquid alkali metal hydroxide. In some embodiments, the concentrated alkali metal hydroxide is from about 69% to about 74% (actives basis) liquid alkali metal hydroxide, preferably from about 70% to about 73% (actives basis) liquid alkali metal hydroxide. The concentrated alkali metal hydroxide is maintained at sufficiently high temperatures to prevent premature solidification. In an embodiment the concentrated alkali metal hydroxide is maintained, handled or otherwise processed at a temperature of at least about 66° C., or from about 66° C. to about 85° C.

In alternative embodiments the concentrated alkali metal hydroxide can include using a mixture of caustic beads and caustic liquid, wherein the methods of making the solid compositions beneficially reduce the use of caustic beads. In such an embodiment, there may still be an initial step of concentrating an alkali metal hydroxide, such as by dissolving a solid alkali metal hydroxide in a liquid alkali metal hydroxide having 50% (actives basis) or less, to provide the concentrated alkali metal hydroxide.

The alkali metal carbonate can be in the solid compositions in an amount of about 1 wt-% to about 99.9 wt-%, about 10 wt-% to about 90 wt-%, about 20 wt-% to about 90 wt-%, about 30 wt-% to about 90 wt-%, about 30 wt-% to about 80 wt-%, about 40 wt-% to about 85 wt-%, or about 30 wt-% to about 70 wt-%.

The alkali metal carbonate can be in the solid compositions in further embodiments in an amount of about 1 wt-% to about 99.9 wt-%, about 1 wt-% to about 70 wt-%, about 1 wt-% to about 50 wt-%, about 5 wt-% to about 50 wt-%, about 5 wt-% to about 40 wt-%, or about 5 wt-% to about 30 wt-%.

In alternative embodiments the alkali metal hydroxide can be present to make the solid compositions in an amount of about 1 wt-% to about 99.9 wt-%, about 10 wt-% to about 90 wt-%, about 20 wt-% to about 90 wt-%, about 30 wt-% to about 90 wt-%, about 30 wt-% to about 80 wt-%, or about 30 wt-% to about 70 wt-%. In other embodiments, the caustic solution includes from about 1 wt-% to about 90 wt-% of the total caustic to make the solid composition. In still other embodiments, the caustic solution includes from about 10 wt-% to about 90 wt-% of the total caustic to make the solid composition.

As described herein a liquid and a solid caustic can be combined to make the solid composition. In some embodiments where a solid caustic is employed the alkali metal hydroxide of the composition comprises less than about 40 wt-% solid caustic bead. In further embodiments where a solid caustic is employed, the composition has at least about 20% less solid caustic bead compared to a solid composition that does not contain the alkali metal hydroxide and reagent (e.g. propylene glycol).

### Polyol

In some embodiments, the solid compositions contain at least one polyol to react with the alkali metal hydroxide to form the solid compositions. Polyols include C1-C22 alcohol, a glycol, or derivative thereof, or a combination thereof. In embodiments, a polyol is a diol, triol, and/or polyol containing more than 3 hydroxyl groups. Diols include for example, ethylene glycol, propylene glycol, hexylene glycol, tetramethylene glycol (1,4-Butanediol), etc. An exemplary triol is glycerin. An exemplary polyol is D-Sorbitol (6 hydroxyl groups).

Exemplary polyols include glycols and derivatives thereof including, ethylene glycol, propylene glycol, hexylene glycol, ethylene glycol phenyl ether, propylene glycol n-propyl ether, propylene glycol phenyl ether, dipropylene glycol n-propyl ether, and the like. Further exemplary glycerols and derivatives include, glycerol ethyl hexyl glyceryl ether, glycerin, glycerol formal, glycerol ketal, and the like. Exemplary polyols, diols and derivatives include, 3-butanediol, 1,4-butanediol, 2-ethy-1,3,-hexanediol, 1-3-propane diol, 2-methyl-2-propyl-1,3-propanediol, and the like.

A preferred polyol is glycerin. In an embodiment crude glycerin (˜85% active) is the preferred polyol. The terms glycerin and glycerol may be used interchangeably. In addition to polyols, additional organic molecules having at least one hydroxyl group to react with the caustic source to form the solid compositions as disclosed in U.S. Patent Application No. 63/490,838, claiming priority to U.S. Ser. No. 63/490,838, filed simultaneously herewith and titled “Alkoxide-Based Solidification Via Control of Reaction Equilibrium and Kinetics”, which is incorporated by reference in its entirety.

According to various embodiments the polyol is included as a reagent to make the solid compositions in an amount of about 1 wt-% to about 30 wt-%, about 1 wt-% to about 20 wt-%, about 1 wt-% to about 15 wt-%, about 1 wt-% to about 10 wt-%, or about 2 wt-% to about 10 wt-%.

### Alkylene Carbonates

In some embodiments, the solid compositions include an alkylene carbonate to react with the caustic source to form the solid composition. Any suitable alkylene carbonate may be used.

Exemplary alkylene carbonates include for example, glycerin carbonate (or glycerol carbonate), ethylene carbonate, propylene carbonate, butylene carbonate, carbonate esters, and the like. A carbonate ester has a carbonyl group flanked by two alkoxy groups. In an embodiment, a cyclic organic ester is provided in the carbonate structure, such as shown for ethylene carbonate, propylene carbonate, and butylene carbonate, as follows respectively, is employed, however, any chain length of the alkyl group can be employed:

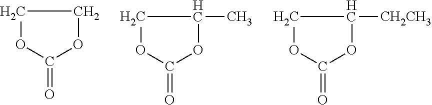

Alkylene carbonates are commercially-available (Huntsman, available under Jeffsol® tradename) and often referred to as glycol carbonates or cyclic carbonates. They are often used as reactive intermediates to replace ethylene and propylene oxides and ethylene and propylene glycols.

In some embodiments glycerin carbonate is a preferred alkalinity source and/or reagent. Glycerol carbonate is a carbonate ester. Glycerol carbonate can be obtainable by esterifying ethylene carbonate or dimethyl carbonate with glycerol, the by-products produced being ethylene glycol or methanol, respectively. A further synthesis route starts from glycidol (2,3-epoxy-1-propanol), which is reacted with CO₂ under pressure in the presence of catalysts to give glycerol carbonate. Glycerol carbonate is a clear, readily mobile liquid which has a density of 1.398 gem-3 and boils at 125-130° C. (0.15 mbar).

In embodiments the molar ratio of the initial alkali metal hydroxide to alkylene carbonate combined to make the solid composition is from about 0.5:1 to about 10:1, or from about 0:71:1 to about 9.8:1.

According to various embodiments the alkylene carbonate is included as a reagent to make the solid compositions in an amount of about 1 wt-% to about 50 wt-%, about 1 wt-% to about 40 wt-%, about 1 wt-% to about 20 wt-%, about 1 wt-% to about 15 wt-%, or about 5 wt-% to about 15 wt-%.

### Chelants

The compositions include a strong chelant (also referred to as a chelating agent). The inclusion of a strong chelant in combination with the surfactants and enzyme provide optimal protein removal performance that overcome limitations of reduced alkalinity content (i.e. from about 20-47%, from about 25-40%, or preferably from about 28-37% total alkalinity as measured by percent Na₂O in the composition) of the compositions.

Examples of chelating agents include phosphonic acid and phosphonates, phosphates, aminocarboxylates and their derivatives, pyrophosphates, ethylenediamine and ethylenetriamine derivatives, hydroxyacids, and mono-, di-, and tri-carboxylates and their corresponding acids. In certain embodiments the composition is phosphate free. Exemplary chelating agents include methylglycine-N,N-diacetic acid (MGDA); glutamic acid-N,N-diacetic acid (GLDA); ethylenediaminetetraacetic acid (EDTA); diethylenetriaminepentacetic acid (DTPA); nitrilotriacetic acid (NTA); Triethylenetetramine-N,N,N′,N″,N′″,N′″-hexaacetic acid (TTHA); Aspartic acid-N,N-diacetic acid (ASDA) and alkali, alkali earth metal, transition metal and/or ammonium salts thereof. In a further embodiment a biodegradable chelating agent, such as an aminocarboxylate is preferred.

Chelants suitable for use in the compositions preferably have a stability constant with calcium that is between about 1×10⁷ and about 1×10¹¹.

In some embodiments, the compositions include a chelant comprising an aminocarboxylate selected from the group consisting of selected from the group consisting of NTA, EDTA, DTPA TTHA, MGDA, and GLDA. In some embodiments, the compositions include a chelant comprising an aminocarboxylate selected from the group consisting of selected from the group consisting of NTA, EDTA, DTPA, MGDA, and GLDA each having a stability constant with calcium that is between about 1×10⁷ and about 1×10¹¹.

In some embodiments, the solid compositions include a chelant comprising sodium gluconate. Without being limited to a particular mechanism of action the inclusion of a strong chelant, namely a biodegradable aminocarboxylate, benefits by increasing the melting point of the solid formed by a caustic/polyol/chelant by further bonding with the chelant.

In some embodiments, the compositions include a chelant comprising a ternary polymer, such as an acrylic acid/maleic acid/ATBS (Acrylamide t-butyl sulfonic acid, N-t-butyl acrylamide sulfonic acid). In an exemplary embodiment the chelant comprises 85% acrylic acid/10% maleic acid/5% ATBS.

The chelant can be in the compositions in an amount of about 1 wt-% to about 20 wt-%, about 2 wt-% to about 20 wt-%, or about 2 wt-% to about 15 wt-%.

### Enzyme

The compositions include a protease enzyme in combination with the surfactants and strong chelant to provide optimal protein removal performance that overcome limitations of reduced alkalinity content (i.e. from about 20-47%, from about 25-40%, or preferably from about 28-37% total alkalinity as measured by percent Na₂O in the composition) of the compositions. Beneficially and without being limited to a mechanism of action, the protease enzyme can be included in the solid compositions as a result of the lower total alkalinity in the compositions compared to conventional caustic-based solids despite compositions including greater wt-% of water contained therein for both liquid and solid compositions.

Various protease enzymes or mixture of proteases, from any source, can be used in the compositions, provided that the selected enzyme is stable in the desired pH range (between about 7.5 and about 12.5). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus lentus, Bacillus licheniformis and Streptomyces griseus. Protease enzymes derived from B. subtilis are most preferred. The protease can be purified or a component of a microbial extract, and either wild type or variant (either chemical or recombinant).

Exemplary proteases are commercially available under the following trade names Alcalase®, Blaze®, Savinase®, Esperase®, and Progress UNO™ (also sold under the name Everis DUO™) each available from Novozymes.

In embodiments the protease enzymes survive as stable enzymes suitable for the cleaning and methods of use described herein over multi-use dispensing cycles as solid compositions representing a significant improvement over conventional enzyme stability in liquid and solid compositions where processing/manufacturing and dispensing are known to significantly reduce concentrations of viable enzymes. It is generally expected for substantial amounts of enzyme to be lost in the processing and thereafter the dispensing of a solid composition to generate a concentrate or use solution. The use of a dry solid containing enzymes does not ensure the enzyme remains stable and effective for use throughout the processing and dispensing, namely generating of a use solution for dispensing. Beneficially, as described herein, the protease enzymes when contacted with water in a dispensing step to generate a concentrate or a use solution from a solid, does not exhibit loss of a substantial enzyme concentration, including over multi-use dispensing cycles. In some embodiments the enzyme concentration is not substantially changed or exhibits less than about a 10% loss in enzyme concentration as can be measured by QA™ 476 (Proteolytic Enzyme Activity by Plate Reader).

The enzyme can be in the compositions in an amount of about 0.1 wt-% to about 10 wt-%, about 0.1 wt-% to about 5 wt-%, about 0.5 wt-% to about 5 wt-%, or about 1 wt-% to about 5 wt-%.

### Additional Functional Ingredients

The compositions may further include additional functional materials or additives that provide a beneficial property, e.g., for a particular use. Examples of conventional additives include one or more of additional alkalinity source, additional surfactants, detersive polymer, cleaning agent, rinse aid composition, softeners, pH modifier, source of acidity, anti-corrosion agent, secondary hardening agent, solubility modifier, detergent builder, detergent filler, defoamer, anti-redeposition agent, antimicrobial sanitizers and/or antimicrobial agents, rinse aids, a threshold agent or system, aesthetic enhancing agent (i.e., dye, odorant, perfume), optical brightener, bleaching agent, enzyme, effervescent agent, activator for an active oxygen compound, other such additives or functional ingredients, and the like, and mixtures thereof. Adjuvants and other additive ingredients will vary according to the type of composition being manufactured, and the intended end use of the solid composition.

In some embodiments, the surfactant compositions for liquid or solid compositions and the compositions themselves are free of silicone surfactants.

In some embodiments, the surfactant compositions for liquid compositions, further include a hydrotrope, viscosity modifier, solvent, water carrier, or derivatives or combinations thereof.

In some embodiments, the surfactant compositions for liquid or solid compositions further include an additional surfactant. Additional nonionic, anionic, amphoteric and zwitterionic surfactants are disclosed, for example in U.S. Patent Application No.

, claiming priority to U.S. Ser. No. 63/490,857, filed simultaneously herewith and titled “Capped Block Copolymers, Their Synthesis, Manufacture, and Methods of Use”, which is incorporated by reference in its entirety.

In some embodiments, the surfactant compositions for liquid or solid compositions further include a water conditioning agent. The term “water conditioning agent” refers to a compound that inhibits crystallization of water hardness ions from solution or disperses mineral scale including but not limited to calcium carbonate. Water conditioning agents can include polymeric and small molecule water conditioning agents. Organic small molecule water conditioning agents are typically organocarboxylate compounds or organophosphate water conditioning agents. Polymeric water conditioning agents commonly comprise polyanionic compositions such as polyacrylic acid compounds.

Additional examples of water conditioning polymers includes polyacrylic acid homopolymer or alkali metal salt thereof, i.e., sodium polyacrylate. The polyacrylic acid homopolymers can contains a polymerization unit derived from the monomer selected from the group consisting of acrylic acid, methacrylic acid, methyl acrylate, methyl methacrylate, ethyl acrylate, ethyl methacrylate, butyl acrylate, butyl methacrylate, iso-butyl acrylate, iso-butyl methacrylate, iso-octyl acrylate, iso-octyl methacrylate, cyclohexyl acrylate, cyclohexyl methacrylate, glycidyl acrylate, glycidyl methacrylate, hydroxyethyl acrylate, hydroxypropyl acrylate, 2-hydroxyethyl acrylate, 2-hydroxyethyl methacrylate, 2-hydroxypropyl acrylate, 2-hydroxypropyl methacrylate, and hydroxypropyl methacrylate and a mixture thereof, among which acrylic acid, methacrylic acid, methyl acrylate, methyl methacrylate, butyl acrylate, butyl methacrylate, iso-butyl acrylate, iso-butyl methacrylate, hydroxyethyl acrylate, 2-hydroxyethyl acrylate, 2-hydroxyethyl methacrylate, 2-hydroxypropyl acrylate, and 2-hydroxypropyl methacrylate, and a mixture thereof are preferred.

Preferred are polyacrylic acids, (C₃H₄O₂)ₙ or 2-Propenoic acid homopolymers; Acrylic acid polymer; Poly(acrylic acid); Propenoic acid polymer; PAA have the following structural formula:

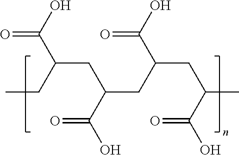

where n is any integer. One source of commercially available polyacrylates (polyacrylic acid homopolymers) includes the Acusol® 445 series from The Dow Chemical Company, Wilmington Delaware, USA, including, for example, Acusol® 445 (acrylic acid polymer, 48% total solids) (4500 MW), Acusol® 445N (sodium acrylate homopolymer, 45% total solids) (4500MW), and Acusol® 445ND (powdered sodium acrylate homopolymer, 93% total solids) (4500MW) Other polyacrylates (polyacrylic acid homopolymers) commercially available from Dow Chemical Company include, but are not limited to Acusol 929 (10,000 MW) and Acumer® 1510. Yet another example of a commercially available polyacrylic acid is AQUATREAT® AR-6 (100,000 MW) from AkzoNobel Strawinskylaan 2555 1077 ZZ Amsterdam Postbus 75730 1070 AS Amsterdam. Other suitable polyacrylates (polyacrylic acid homopolymers) include, but are not limited to those obtained from additional suppliers such as Aldrich Chemicals, Milwaukee, Wis., and ACROS Organics and Fine Chemicals, Pittsburgh, Pa, BASF Corporation and SNF Inc. The homopolymers, copolymers, and/or terpolymers may be present in a composition from about 0.01 wt-% to about 30 wt-%. Maleic anhydride/olefin copolymers are copolymers of polymaleic anhydrides and olefins. Maleic anhydride (C₂H₂(CO)₂O has the following structure:

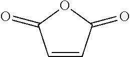

A part of the maleic anhydride can be replaced by maleimide, N-alkyl(C₁₋₄) maleimides, N-phenyl-maleimide, fumaric acid, itaconic acid, citraconic acid, aconitic acid, crotonic acid, cinnamic 10 acid, alkyl (C₁₋₁₈) esters of the foregoing acids, cycloalkyl(C₃₋₈) esters of the foregoing acids, sulfated castor oil, or the like. At least 95 wt % of the maleic anhydride polymers, copolymers, or terpolymers have a number average molecular weight of in the range between about 700 and about 20,000, preferably between about 1000 and about 100,000. A variety of linear and branched chain alpha-olefins can be used for the purposes of this disclosure. Particularly useful alpha-olefins are dienes containing 4 to 18 carbon atoms, such as butadiene, chloroprene, isoprene, and 2-methyl-1,5-hexadiene; 1-alkenes containing 4 to 8 carbon atoms, preferably C₄₋₁₀, such as isobutylene, 1-butene, 1-hexene, 1-octene, and the like.

In a preferred embodiment, particularly suitable maleic anhydride/olefin copolymers have a molecular weight between about 1000 and about 50,000, in a preferred embodiment between about 5000 and about 20,000, and in a most preferred embodiment between about 7500 and about 12,500. Examples of maleic anhydride/olefin copolymers which may be used include, but are not limited to, Acusol 460N from The Dow Chemical Company, Wilmington Delaware, USA. The maleic anhydride/olefin copolymer may be present in a composition from about 0.01 wt-% to about 30 wt-%.

Additional polymers include polycarboxylic acid polymers, include, but are not limited to, polymaleic acid homopolymers, polyacrylic acid copolymers, and maleic anhydride/olefin copolymers. Polymaleic acid (C₄H₂O₃)_{X} or hydrolyzed polymaleic anhydride or cis-2-butenedioic acid homopolymer, has the structural formula:

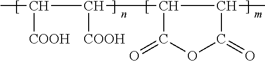

where n and m are any integer. Examples of polymaleic acid homopolymers, copolymers, and/or terpolymers (and salts thereof) which may be used are particularly preferred are those with a molecular weight of about 0 and about 5000, more preferably between about 200 and about 2000 (can you confirm these MWs). Commercially available polymaleic acid homopolymers include the Belclene 200 series of maleic acid homopolymers from BWA™ Water Additives, 979 Lakeside Parkway, Suite 925 Tucker, GA 30084, USA and Aquatreat AR-801 available from AkzoNobel. The polymaleic acid homopolymers, copolymers, and/or terpolymers may be present in a composition from about 0.01 wt-% to about 30 wt-%.

Inorganic water conditioning agents include, but are not limited to, sodium tripolyphosphate and other higher linear and cyclic polyphosphates species. Suitable condensed phosphates include sodium and potassium orthophosphate, sodium and potassium pyrophosphate, sodium tripolyphosphate, and sodium hexametaphosphate. A condensed phosphate may also assist, to a limited extent, in solidification of the solid detergent composition by fixing the free water present in the composition as water of hydration. Examples of phosphonates included, but are not limited to: 1-hydroxyethane-1,1-diphosphonic acid, CH₃C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂CH₂N[CH₂PO(OH)₂]₂]₂; diethylenetriaminepenta(methylenephosphonate), sodium salt (DTPMP), C₉H₂₈₋ₓN₃NaₓO₁₅P₅ (x=7); hexamethylenediamine (tetramethylenephosphonate), potassium salt, C₁₀H₂₈₋ₓN₂KₓO₁₂P₄ (x=6); bis(hexamethylene)triamine (pentamethylenephosphonic acid), (HO₂)POCH₂N [(CH₂)₆N[CH₂PO(OH)₂]₂]₂; and phosphorus acid, H₃PO₃. A preferred phosphonate combination is ATMP and DTPMP. A neutralized or alkaline phosphonate, or a combination of the phosphonate with an alkali source before being added into the mixture such that there is little or no heat or gas generated by a neutralization reaction when the phosphonate is added is preferred.

In some embodiments, the surfactant compositions for solid compositions further include a hydrotrope, viscosity modifier, solvent, water carrier, or derivatives or combinations thereof.

In some embodiments, the solid compositions further include a functional anhydrous material to absorb excess water from the mixture of hydrated solids in the composition. Examples of such a functional anhydrous material, include, but are not limited to, sodium carbonate (ash), sodium sulfate, and the like. Without being limited to a particular mechanism, the addition of a functional anhydrous material forms hydrate compounds upon contact with excess water, thus removing the excess water from the mixture.

In some embodiments, the surfactant compositions for liquid or solid compositions further include an anti-redeposition agent, namely that is capable of facilitating sustained suspension of soils in a cleaning or rinse solution and preventing removed soils from being redeposited onto the substrate being cleaned and/or rinsed. Some examples of suitable anti-redeposition agents can include fatty acid amides, fluorocarbon surfactants, complex phosphate esters, styrene maleic anhydride copolymers, and cellulosic derivatives such as hydroxyethyl cellulose, hydroxypropyl cellulose, and the like. A composition can include up to about 10 wt-%, and in some embodiments, in the range of about 1 to about 5 wt-%, of an anti-redeposition agent.

In some embodiments, the surfactant compositions for liquid or solid compositions further include one or more functional polydimethylsiloxones. For example, in some embodiments, a polyalkylene oxide-modified polydimethylsiloxane, nonionic surfactant or a polybetaine-modified polysiloxane amphoteric surfactant can be employed as an additive. Both, in some embodiments, are linear polysiloxane copolymers to which polyethers or polybetaines have been grafted through a hydrosilation reaction. Some examples of specific siloxane surfactants are known as SILWET® surfactants available from Union Carbide or ABIL® polyether or polybetaine polysiloxane copolymers available from Goldschmidt Chemical Corp., and described in U.S. Pat. No. 4,654,161 which patent is incorporated herein by reference. In some embodiments, the particular siloxanes used can be described as having, e.g., low surface tension, high wetting ability and excellent lubricity. For example, these surfactants are said to be among the few capable of wetting polytetrafluoroethylene surfaces. The siloxane surfactant employed as an additive can be used alone or in combination with a fluorochemical surfactant. In some embodiments, the fluorochemical surfactant employed as an additive optionally in combination with a silane, can be, for example, a nonionic fluorohydrocarbon, for example, fluorinated alkyl polyoxyethylene ethanols, fluorinated alkyl alkoxylate and fluorinated alkyl esters.

Further description of such functional polydimethylsiloxones and/or fluorochemical surfactants are described in U.S. Pat. Nos. 5,880,088; 5,880,089; and 5,603,776, all of which patents are incorporated herein by reference. We have found, for example, that the use of certain polysiloxane copolymers in a mixture with hydrocarbon surfactants provides excellent rinse aids on plastic ware. We have also found that the combination of certain silicone polysiloxane copolymers and fluorocarbon surfactants with conventional hydrocarbon surfactants also provide excellent rinse aids on plastic ware. This combination has been found to be better than the individual components except with certain polyalkylene oxide-modified polydimethylsiloxanes and polybetaine polysiloxane copolymers, where the effectiveness is about equivalent. Therefore, some embodiments encompass the polysiloxane copolymers alone and the combination with the fluorocarbon surfactant can involve polyether polysiloxanes, the nonionic siloxane surfactants. The amphoteric siloxane surfactants, the polybetaine polysiloxane copolymers may be employed alone as the additive in the end-use compositions to provide the same results.

In some embodiments, the end-use compositions may include functional polydimethylsiloxones in an amount in the range of up to about 10 wt. %. For example, some embodiments may include in the range of about 0.1 to 10 wt. % of a polyalkylene oxide-modified polydimethylsiloxane or a polybetaine-modified polysiloxane, optionally in combination with about 0.1 to 10 wt. % of a fluorinated hydrocarbon nonionic surfactant.

The compositions can be formulated as liquids or solids. Liquids can include for example, a slurry, or structured liquid, or emulsion. The solid compositions refer to “solid forms” that are hardened compositions that will not flow and will substantially retain its shape under moderate stress or pressure or mere gravity. The degree of hardness of the solid cast composition may range from that of a fused solid product which is relatively dense and hard, for example, like concrete, to a consistency characterized as being a hardened paste. In addition, the term “solid” refers to the state of the composition under the expected conditions of storage and use of the solid composition. In general, it is expected that the composition will remain in solid form when exposed to temperatures of up to approximately 100° F. and particularly greater than approximately 120° F.

The solid compositions may take forms including, but not limited to: a pressed solid; a cast solid product; an extruded, molded or formed solid pellet, block, tablet, powder, granule, flake; or the formed solid can thereafter be ground or formed into a powder, granule, or flake. In an exemplary embodiment, extruded pellet materials formed have a weight of between approximately 1 gram and 50 grams, or 50 grams and approximately 250 grams, extruded solids generally have a weight of approximately 100 grams or greater, and solid blocks generally have a mass of between approximately 1 and approximately 10 kilograms. The solid compositions provide for a stabilized source of functional materials.

In some embodiments employing an alkoxide solidification (e.g. alkali metal hydroxide and an alkylene carbonate) and/or solid compositions employing the various alkalinity sources without alkoxides, provide a storage stable solid composition i including the protease enzyme, beneficially wherein the protease enzyme is stable during cast processing, storage, and wet conditions during dispensing cycles. Beneficially the solid compositions have not only storage, shelf, and dimensional stability but also provide a superior enzyme stability within the solid compositions and in their use solutions during multiple dispensing cycles.

In embodiments the storage, shelf, and dimensional stability of the solids include under an elevated temperatures. The enzymatic activity in these solid compositions and use solutions thereof is retained over time and under elevated temperature conditions. In embodiments the solid compositions and use solutions thereof are stable at room temperature, and further stable at temperatures up to about 50° C. Still further such shelf stability of the use solutions may be important for applications of use that keep a use dilution for use over an extended period of times, such as hours, days, or weeks. Beneficially, the use compositions of the solid compositions maintain shelf stability for at least about 1 year, or at least about 6 months, at room temperature.

Moreover, the solid compositions maintain shelf stability in solid form, including at elevated storage temperatures, including for example at temperatures up to at least 40° C. (or 100° F.) for at least 8 weeks with a growth exponent (or change in dimension of the solid in any direction) of less than about 3%, demonstrating shelf stability at room temperature or ambient temperatures for at least about 1 year. It was unexpected for the solid compositions to exhibit both solid stability and use composition stability with maintained enzyme stability for extended periods of time.

In some embodiments, the solid compositions have a dimensional stability and has a growth exponent of less than about 3% if heated at a temperature of about 122° F. In some other embodiments, the solid detergent has a dimensional stability and has a growth exponent of less than about 2% if heated at a temperature of about 122° F.

In some embodiments, the solid composition may be dissolved, for example, in an aqueous or other medium, to create a concentrated and/or use solution. The solution may be directed to a storage reservoir for later use and/or dilution, or may be applied directly to a point of use. Alternatively, the solid alkaline composition is provided in the form of a unit dose, typically provided as a cast solid, an extruded pellet, or a tablet having a size of between approximately 1 gram and approximately 100 grams. In another alternative, multiple-use solids can be provided, such as a block or a plurality of pellets, and can be repeatedly used to generate aqueous compositions for multiple cycles.

### Methods of Use

The compositions beneficially provide highly effective protein removal and synergy as a result of the alkalinity, detersive and defoaming surfactants, strong chelant and protease enzyme. Various applications of use and methods of using are described herein. In some embodiments warewashing compositions, rinse aid or bottle washing anti-foam compositions are provided. Various applications where protein removal is desired are envisioned with the compositions and methods described herein.

The methods of using the compositions described herein include generating a use solution (of either a liquid or solid composition, including single or multi-use solids), contacting an article or surface in need of protein removal and/or defoaming and cleaning, disinfecting, and/or sanitizing with the use solution, and cleaning, disinfecting, and/or sanitizing the article or surface. The compositions can be referred to herein as cleaning compositions which are suitable for various applications of use.

In embodiments the pH of a use solution generated from dilution of the compositions is at least about 7.5, from about 7.5 to about 14, or from about 7.5 to about 12.

As referred to herein, the term ‘antifoaming’ means the compositions do not generate significant or any foam. The antifoaming prevents the generation of foam, whereas ‘defoaming’ means the surfactant composition and the compositions employing the same reduce the presence of foam.

In some embodiments, where a solid is provided, the solid composition does not slough during dispensing to generate the use solution.

In embodiments where a solid is provided, the solid composition provides a stable protease enzyme. In further embodiments for solid compositions that are multi-use compositions, the protease enzyme is beneficially stabilized to survive multi-use dispensing. In such embodiments, a concentrate or use solution is formed by contacting the solid composition with water to generate the solution over multiple dispensing cycles. In some embodiments, the solid is dispensed over multiple days or weeks based on the number of cycles run with the multi-use solid compositions. In some embodiments, the solid is dispensed from about 5 cycles to about 100 cycles, or from about 20 cycles to about 100 cycles. Beneficially, the protease enzyme concentration in the concentrate or use solution therefrom is stable and substantially no enzyme concentration is lost by the multi-use dispensing cycles. Without being limited to a particular mechanism of action the enzyme stability in the multi-use solid compositions is afforded by the binding of the alkoxide solid and/or reagents for forming alkoxides, e.g. alkylene carbonates such as glycerol carbonate, afforded in solid compositions than can include a significant water concentration as described herein.

In various embodiments, it is a benefit that the compositions comprise from about 20-47%, from about 25-40%, or preferably from about 28-37% total alkalinity as measured by percent Na₂O in the composition to provide improved cleaning performance in comparison to compositions comprising additional alkali metal hydroxide. In other embodiments, it is a benefit that the compositions comprise less than about 70:30 alkali metal hydroxide to water weight ratio to provide improved cleaning performance in comparison to compositions comprising additional alkali metal hydroxide. In either of these embodiments, the compositions are less concentrated caustic compositions (or less concentrated alkaline compositions) and therefore allow for additional performance additives, including the surfactants, chelant and enzyme to improve the cleaning performance. For example, in an embodiment the compositions can contain less active caustic (after neutralization from acidic components) in the composition compared to inline solid caustic machine ware washing detergents and provide at least the same or improved cleaning efficacy.

In other embodiments, compositions employing greater alkalinity are preferred, such as for example, bottle washing, rinsing and/or pulp processing. In such embodiments, solid or liquid compositions employing the surfactant compositions are preferred.

The present disclosure includes methods of using the compositions for various cleaning applications. These cleaning compositions can operate on an article, surface, in a body or stream of water or a gas, or the like, by contacting the article, surface, body, or stream with a composition of the disclosure. Contacting can include any of numerous methods for applying a cleaning composition of the disclosure, such as spraying the compositions, immersing the article in compositions, foam or gel treating the article with the compounds or composition, or a combination thereof.

It should be understood that the concentration of the ingredients in the compositions will vary depending on whether the cleaning composition is provided as a concentrate or as a use solution. A use solution may be prepared from the concentrate by diluting the concentrate with water at a dilution ratio that provides a use solution having desired detersive properties.

Exemplary industries in which the present methods can be used include, but are not limited to: food service industry; food and beverage industry; and the pharmaceutical manufacturing industry. Suitable uses for the compositions and methods of the invention may include, for example, bottle washing, machine warewashing, pulp antifoaming rinse aid, and the like.

The present methods can also be used to remove various types of soils. Such other soils include, but are not limited to, starch, cellulosic fiber, protein, simple carbohydrates and combinations of any of these soil types with mineral complexes. Examples of specific food soils that are effectively removed using the present methods include, but are not limited to, soils generated in the manufacture and processing meat, poultry, vegetables and fruit, bakery goods, soft drinks, brewing and fermentation residues, soils generated in sugar beet and cane processing and processed foods containing these ingredients and associated ingredients such as juices, sauces and condiments. These soils can develop on environmental surfaces such as walls and floors, freezers and cooling systems, heat exchange equipment surfaces, conveyor surfaces and on other surfaces during the manufacturing and packaging process.

In further embodiments, the methods of employing cleaning compositions are particularly suited for use in closed systems, e.g. dish or ware washing systems for cleaning, bottle washing systems and processes, sanitizing and/or disinfecting articles and surfaces.

The method includes contacting an article or surface with a cleaning composition or a cleaning use composition to wash the surface. The method can contact the liquid to any of a variety of surfaces or objects including surfaces or articles including those made of glass, ceramic, plastic, porcelain, aluminum, or the like.

The phrase “washing a surface with a wash solution (or a use solution or a cleaning composition)” refers to the circulation of a cleaning composition solution to remove substantially all soil from the treated surfaces (e.g. ware) and to keep that soil suspended or dissolved. In an embodiment, this step may be conducted where the temperature of the rinse water is up to about 140° F., preferably in the range of 100° F. to 140° F., preferably in the range of 110° F. to 140° F., and most preferably in the range of 120° F. to 140° F. As referred to herein, “low temperature” refers to those rinse water temperatures below about 140° F. For example, conventional rinse temperature for ware washing occurs above 140° F., such as from about 140° F. to about 190° F., particularly between about 145° F. to about 180° F. In an aspect, the methods employing a low temperature further employ a sanitizer.

Contacting can include any of numerous methods for applying a cleaning composition, such as spraying the composition, immersing the object in the composition, or a combination thereof. A concentrate or use concentration of a composition can be applied to or brought into contact with an article by any conventional method or apparatus for applying a cleaning composition to an object. For example, the object can be wiped with, sprayed with, and/or immersed in the composition, or a use solution made from the composition. The composition can be sprayed, or wiped onto a surface; the composition can be caused to flow over the surface, or the surface can be dipped into the composition. Contacting can be manual or by machine.

Before contacting an article or surface, a concentrate cleaning composition may be first diluted with water at the location of use to provide the use solution. When the composition is used in an automatic warewashing or dishwashing machine, it is expected that that the location of use will be inside the automatic warewashing machine. Depending on the machine, the composition may be provided in a unit dose form or in a multi-use form. In larger warewashing machines, a large quantity of composition may be provided in a compartment that allows for the release of a single dose amount of the composition for each wash cycle. Such a compartment may be provided as part of the warewashing machine or as a separate structure connected to the warewashing machine.

The cleaning composition may also be dispensed from a spray-type dispenser, such as that disclosed in U.S. Pat. Nos. 4,826,661, 4,690,305, 4,687,121, 4,426,362 and in U.S. Pat. Nos. Reissue 32,763 and 32,818, the disclosures of which are incorporated by reference herein. Briefly, a spray-type dispenser functions by impinging a water spray upon an exposed surface of the composition, and then immediately directing the use solution out of the dispenser to a storage reservoir or directly to a point of use. If necessary, in some embodiments, when used, the product may be removed from the packaging and inserted into the dispenser.

The methods may further employ one or more rinse steps for the treated articles or surfaces.

In some embodiments, the cleaning compositions include killing one or more of the pathogenic bacteria associated with health care surfaces and environments including, but not limited to, Salmonella typhimurium, Staphylococcus aureus, methicillin resistant Staphylococcus aureus, Salmonella choleraesurus, Pseudomonas aeruginosa, Escherichia coli, mycobacteria, yeast, and mold. The cleaning compositions have activity against a wide variety of microorganisms such as Gram positive (for example, Listeria monocytogenes or Staphylococcus aureus) and Gram negative (for example, Escherichia coli or Pseudomonas aeruginosa) bacteria, yeast, molds, bacterial spores, viruses, etc. The compounds and compositions of the present disclosure, as described above, have activity against a wide variety of human pathogens. The cleaning compositions can kill a wide variety of microorganisms on a food processing surface, on the surface of a food product, in water used for washing or processing of food product, on a health care surface, or in a health care environment.

The present methods can be used to achieve any suitable reduction of the microbial population in and/or on the target or the treated target composition. In some embodiments, the present methods can be used to reduce the microbial population in and/or on the target or the treated target composition by at least one log10. In other embodiments, the present methods can be used to reduce the microbial population in and/or on the target or the treated target composition by at least two log10. In still other embodiments, the present methods can be used to reduce the microbial population in and/or on the target or the treated target composition by at least three log10. In still other embodiments, the present methods can be used to reduce the microbial population in and/or on the target or the treated target composition by at least five log10. Without limiting the scope of disclosure, the numeric ranges are inclusive of the numbers defining the range and include each integer within the defined range.

The cleaning compositions can be used for a variety of domestic or industrial applications, e.g., to reduce microbial or viral populations on a surface or object or in a body or stream of water. The cleaning compositions can be applied in a variety of areas including kitchens, bathrooms, factories, hospitals, dental offices and food plants, and can be applied to a variety of hard or soft surfaces having smooth, irregular or porous topography. Suitable hard surfaces include, for example, architectural surfaces (e.g., floors, walls, windows, sinks, tables, countertops and signs); eating utensils; hard-surface medical or surgical instruments and devices; and hard-surface packaging. Such hard surfaces can be made from a variety of materials including, for example, ceramic, metal, glass, wood or hard plastic. Suitable soft surfaces include, for example paper; filter media; hospital and surgical linens and garments; soft-surface medical or surgical instruments and devices; and soft-surface packaging. Such soft surfaces can be made from a variety of materials including, for example, paper, fiber, woven or nonwoven fabric, soft plastics and elastomers. The cleaning compositions can also be applied to soft surfaces such as food and skin (e.g., a hand). The present compounds can be employed as a non-foaming environmental sanitizer or disinfectant.

The cleaning compositions can be applied to microbes or to soiled or cleaned surfaces using a variety of methods. These methods can operate on an object, surface, in a body or stream of water or a gas, or the like, by contacting the object, surface, body, or stream with a compound of the disclosure. Contacting can include any of numerous methods for applying a compound, such as spraying the compound, immersing the object in the compound, foam or gel treating the object with the compound, or a combination thereof.

A concentrate or use concentration of a cleaning composition can be applied to or brought into contact with an object by any conventional method or apparatus for applying an antimicrobial or cleaning compound to an object. For example, the object can be wiped with, sprayed with, foamed on, and/or immersed in the compound, or a use solution made from the composition. The cleaning composition can be sprayed, foamed, or wiped onto a surface; the composition can be caused to flow over the surface, or the surface can be dipped into the cleaning composition. Contacting can be manual or by machine. Food processing surfaces, food products, food processing or transport waters, and the like can be treated with liquid, foam, gel, aerosol, gas, wax, solid, or powdered stabilized compounds according to the disclosure, or solutions containing these compounds.

Cleaning compositions of the disclosure can be formulated and sold for use as is, or as solvent or solid concentrates. If desired, such concentrates can be used full-strength as sanitizing rinse compositions. However, the concentrates typically will be diluted with a fluid (e.g., water) that subsequently forms the dilute phase or a use solution. Preferably, the concentrate forms a single phase before such dilution and remains so while stored in the container in which it will be sold. When combined with water or other desired diluting fluid at an appropriate dilution level and subjected to mild agitation (e.g., by stirring or pumping the composition), some compositions of the disclosure will form a pseudo-stable dispersion, and other compositions of the disclosure will form a clear or quasi-stable solution or dispersion. If a pseudo-stable composition is formed, then the composition preferably remains in the pseudo-stable state for a sufficiently long period so that the composition can be applied to a surface before the onset of phase separation. The pseudo-stable state need only last for a few seconds when suitably rapid application techniques such as spraying are employed, or when agitation during application is employed. The pseudo-stable state desirably lasts for at least one minute or more after mixing and while the composition is stored in a suitable vessel, and preferably lasts for five minutes or more after mixing. Often normal refilling or replenishment of the applicator (e.g., by dipping the applicator in the composition) will provide sufficient agitation to preserve the pseudo-stable state of the composition during application.

The various applications of use described herein provide the cleaning compositions to a surface and/or water source. Beneficially, the cleaning compositions of the disclosure are fast-acting. However, the present methods require a certain minimal contact time of the compositions with the surface or product in need of treatment for occurrence of sufficient antimicrobial effect. The contact time can vary with concentration of the use compositions, method of applying the use compositions, temperature of the use compositions, pH of the use compositions, amount of the surface or product to be treated, amount of soil or substrates on/in the surface or product to be treated, or the like. The contact or exposure time can be about 15 seconds, at least about 15 seconds, about 30 seconds or greater than 30 seconds. In some embodiments, the exposure time is about 1 to 5 minutes. In other embodiments, the exposure time is a few minutes to hours. In other embodiments, the exposure time is a few hours to days. The contact time will further vary based upon the use concentration of actives of compositions according to the disclosure.

All publications and patent applications in this specification are indicative of the level of ordinary skill in the art to which this disclosure pertains. All publications and patent applications are herein incorporated by reference to the same extent as if each individual publication or patent application was specifically and individually indicated as incorporated by reference.

### EMBODIMENTS

The present disclosure is further defined by the following numbered embodiments:

1. Compositions comprise: alkalinity source comprising an alkali metal hydroxide, alkali metal carbonate and/or reagents comprising an organic molecule having at least one hydroxyl group or an alkylene carbonate; a first surfactant comprising a first reverse EO/PO block copolymer of about 10-40% EO; and an optional second surfactant comprising at least one of a second reverse EO/PO block copolymer of about 40-50% EO, an alkyl capped alcohol ethoxylate, a capped block copolymer, and alkyl pyrrolidone; a strong chelating agent having a stability constant with calcium that is at least about 1×10⁷; and a protease enzyme, wherein the composition is a liquid or solid and has between from about 20-47%, from about 25-40%, or preferably from about 28-37% total alkalinity as measured by percent Na₂O in the composition.

2. The composition of embodiment 1, wherein the first reverse EO/PO block copolymer is about 20% EO.

3. The composition of any one of embodiments 1-2, wherein second reverse EO/PO block copolymer is about 40% EO.

4. The composition of any one of embodiments 1-3, wherein the first surfactant comprises from about 0.1 wt-% to about 5 wt-% of the composition and/or wherein the second surfactant(s) comprises from about 0.1 wt-% to about 20 wt-% of the composition.

5. The composition of any one of embodiments 1-4, wherein the second surfactant is the alkyl capped alcohol ethoxylate having the structure: R₁—O—(CH₂CH₂O)ₙ—R₂ where R₁ is a linear or branched (C₁₀-C₁₈) alkyl group, R₂ is C₁-C₄, and n is an integer in the range of 1 to 100, or preferably wherein the alkyl capped alcohol ethoxylate is a butyl capped alcohol ethoxylate.

6. The composition of any one of embodiments 1-5, wherein the second surfactant is the alkyl pyrrolidone is C8 or C10 alkyl pyrrolidone.

7. The composition of any one of embodiments 1-6, wherein the chelant is selected from the group consisting of NTA, EDTA, DTPA TTHA, MGDA, GLDA, and a ternary polymer comprising acrylic acid/maleic acid/ATBS.

8. The composition of any one of embodiments 1-7, wherein the protease enzyme is Esperase 6.0T.

9. The composition of any one of embodiments 1-8, further comprising a hydrotrope and/or water conditioning polymer.

10. The composition of any one of embodiments 1-9, wherein the alkalinity source comprises alkali metal carbonate and/or alkali metal hydroxide, and preferably wherein the alkalinity source comprises both alkali metal carbonate and alkali metal hydroxide, wherein the wt-% of the alkali metal carbonate exceeds the wt-% of the alkali metal hydroxide.

11. The composition of embodiment 10, further comprising an alkylene carbonate that is glycerin carbonate, ethylene carbonate, propylene carbonate, or butylene carbonate, and wherein the molar ratio of the initial alkali metal hydroxide to alkylene carbonate combined to make the solid composition is from about 0.5:1 to about 10:1.

12. The composition of any one of embodiments 10-11, wherein the composition is free of solid alkali metal hydroxide beads, or wherein the composition has at least about 50% less solid alkali metal hydroxide beads compared to a caustic beads containing solid composition that does not contain a polyol or the alkylene carbonate forming the solid composition.

13. The composition of any one of embodiments 1-9, wherein the alkalinity source comprises an organic molecule having at least one hydroxyl group and alkali metal hydroxide.

14. The composition of embodiment 13, wherein the weight ratio of the alkali metal hydroxide to water in the solid composition is from about 27:73 to about 75:25, from about 50:50 to about 75:25, or from about 60:40 to about 70:30.

15. The composition of embodiment 13, further comprising water, and wherein the wherein the molar ratio of alkali metal hydroxide to water in the solid is about 1:2.2 to about 1:1.

16. The composition of any one of embodiments 13-15, wherein the organic molecule having at least one hydroxyl group is a polyol, and optionally wherein the polyol comprises glycol, glycerin or sorbitol.

17. The composition of any one of embodiments 13-16, wherein the composition has at least about 20% less solid alkali metal hydroxide beads, or wherein the composition has at least about 40% less solid alkali metal hydroxide beads compared to a solid composition that does not contain the alkali metal hydroxide and the organic molecule having at least one hydroxyl group forming the solid composition.

18. The composition of any one of embodiments 1-17, wherein the solid composition is formed in-situ.

19. The composition of any one of embodiments 1-17, wherein the solid composition is contiguous solid, powder or granule.

20. The composition of embodiment 19, wherein the solid composition is a pressed, cast, or extruded solid, and/or wherein the solid composition is a multi-use composition and the protease enzymes is stabilized therein as measured by enzyme surviving the multi-use dispensing.

21. The composition of any one of embodiments 1-20, wherein alkalinity source(s) comprises from about 20 wt-% to about 80 wt-%, the chelant comprises from about 2 wt-% to about 15 wt-%, the enzyme comprises from about 1 wt-% to about 5 wt-%, and wherein the first and second surfactants comprise from about 0.1 wt-% to about 50 wt-% of the composition.

22. The composition of embodiment 21, wherein the first surfactant comprising the reverse EO/PO block copolymer having 10-40% EO comprises from about 0.1 wt-% to about 5 wt-%, and wherein the second surfactant(s) comprise from about 0.1 wt-% to about 20 wt-% of the composition.

23. Methods of generating a use solution of the compositions described herein comprise: contacting an article or surface in need of soil removal with the use solution; and cleaning to remove the soil from the article or surface, wherein the soil comprises protein.

24. The method of embodiment 23, wherein the use solution is between about 50 ppm to about 5,000 ppm, or about 100 ppm to about 2,000 ppm of the solid composition.

25. The method of any one of embodiments 23-24, wherein the use solution is applied in a ware washing machine and optionally the use solution is contact with the articles of ware therein at a temperature range of about 120-180° F.

26. The method of any one of embodiments 23-25, wherein the use solution is applied in a ware wash machine.

27. The method of any one of embodiments 23-24, wherein the use solution is applied in a laundry or textile care washing machine.

28. The method of any one of embodiments 23-24, wherein the surface is a hard surface, instrument or ware.

29. The method of any one of embodiments 23-28, wherein the step of generating a use solution is by diluting a multi-use solid composition and wherein the protease enzyme survives the multi-use dispensing.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following ingredients are utilized in the Examples:

Acusol 448—an acrylic acid dispersant copolymer, commercially available from Dow Chemical.

Achieve Choice 150 T—Achieve® Advance 150 T is a compact amylase enzyme.

Esperase 6.0T: minimum enzyme activity of 6.0 KNPU/g. and is in the class of subtilisin derived from bacillus subtillis (EC 3.4.21.62)

Belclene 200—a poly maleic acid (50%), commercially available from Italmatch.

Briquest 301 (ATMP) (50%)—aminotris(methylenephosphonic acid) chelant.

Dissolvine DZ (DTPA)—Diethylenetriaminepentaacetic Acid (DTPA) chelant.

LD 097—a polyoxypropylene polyoxyethylene reverse block copolymer, 26% EO, 30% PO.

Nalco DVS3C₀₀₈—a phosphinic acid, sodium salt.

Pluronic 25R₂—a reverse block copolymer, 20% EO, commercially available from BASF.

Tetronic 90R₄—ethylenediamine tetrakis(ethoxylate-block-propoxylate) tetrol, commercially available from BASF.

Chelant00929—85% ACRYLIC ACID, 10% MALEIC ACID, 5% ATBS, noncommercially available polymer ternary polymer.

Pluronic 25-R-2: long chain EO/PO block copolymer

Pluronic N3—a reverse block copolymer, PO EO PO Block Copolymer 1:1 Blend of MW 3100-20% EO & MW 3600-40% EO; 96%; nonionic surfactant.

Commercially available sodium hydroxide (50%), water, sodium aluminate, sodium xylene sulfonate (40%, SXS), sodium xylene sulfonate (96%, SXS), glycerol carbonate, sodium carbonate, D-sorbitol, and esperase enzyme.

### Example 1

10-cycle warewash protein soil removal testing was conducted on various experimental formulations. To test the ability of compositions to clean, 2 coated ceramic tiles were used. The ceramic tiles were cleaned prior to use.

A food soil solution was prepared using a 50/50 combination of Hot point soil and dosed at 2000 ppm soil. The soil included two cans of Dinty Moore Beef Stew (1360 grams), one large can of tomato sauce (822 grams), 15.5 sticks of Blue Bonnet Margarine (1746 grams) and powered milk (436.4 grams). The hot point soil was added to the machine to maintain a sump concentration of about 2000 ppm. In addition, the ceramic tiles were painted with a 1:1 mixture of whole milk and cream of chicken soup. In some experiments, both glass and plastic wares were tested for both protein removal and soil redepositon.

The dish machine was turned on and allowed to reach between 150-160° F. After the dish machine reached the proper temperature, 1000 ppm of detergent was dosed per cycle with 1000 ppm of detergent and 5 grain water. Testing was conducted in a Hobart AM15 ware wash machine. The final rinse temperature was adjusted to about 180-195° F. The ceramic tiles and/or glass and plastic were placed in the dish machine. The dish machine was then started and run through an automatic cycle. At the beginning of each cycle the appropriate amount of hot point soil was added to maintain the sump concentration of 2000 ppm. When the 10 cycles ended, the ceramic tiles were allowed to dry overnight. Thereafter they were graded for spots and film accumulation (visual).

The ceramic tiles were then graded for protein accumulation using Coomassie Brilliant Blue R stain followed by destaining with an aqueous acetic acid/methanol solution. The Coomassie Brilliant Blue R stain was prepared by combining 1.25 g of Coomassie Brilliant Blue R dye with 45 mL of acetic acid and 455 mL of 50% methanol in distilled water. The destaining solution consisted of 45% methanol and 10% acetic acid in distilled water. Blue dye from the Coomassie blue highlighted the protein present on the tiles. The darkest areas on the tiles showed where the most protein was present.

The resulting color was measured using a CIELAB type protocol (as described in the reference: Measurement and Control of the Optical Properties of Paper, by S. J. Popson et al., Technidyne Corp., New Albany, Ind. (1996)). The results are measured according to the following data:
L*—The light to dark number in the color solid. 0=totally black, 100=totally white. This is the number used for Percent Soil Removal calculations.
a*—The red to green number in the color solid. A positive number is toward red and a negative number is toward green.
b*—The yellow to blue number in the color solid. A positive number is toward yellow and a negative number is toward blue.

The first test formulation incorporated the alkylene carbonate, alkali metal hydroxide, and alkali metal carbonate alkalinity (eliminating use of caustic beads) with surfactants and an MGDA chelant as shown in Table 2. This formulation included an alkaline cast solid with MGDA and no enzyme.

TABLE 2

| Description - Composition 1 | Wt-% |
|---|---|
| NaOH 50% | 20.42 |
| Belclene 200 Poly Maleic Acid (50%) | 3.00 |
| Acusol 448 | 3.00 |
| Briquest 301 (ATMP) 50% | 1.04 |
| Trilon M Granules (MGDA) | 8.05 |
| Pluronic 25R2 (Defoamer) | 0.75 |
| Glycerol Carbonate | 9.97 |
| Sodium Xylene Sulfonate 96% | 1.97 |
| Sodium Carbonate, anhyd. | 50.72 |
| Esperase 6.0T | 1.08 |
| Achieve Choice 150 T | 0.10 |
| Total | 100 |
| % Alkalinity, Na₂O | 37% |

Reflectance (CIELAB), L*, a*, b*
L* = 18.9
a* = 0.75
b* = −16.1

The L*, a*, b* results measured and reported in Table 2 show poor warewash results (which were confirmed by visual assessment of ceramic tiles) with level of blueness indicating poor to marginal removal of protein soil.

Additional testing was conducted using another zero percent caustic bead formulation with alternative chelant and polymer composition with the inclusion of an enzyme as shown in Table 3. This formulation resulted in an alkaline cast solid with MGDA, ATMP, Belclene and enzyme.

TABLE 3

| Description - Composition 2 | Wt-% |
|---|---|
| NaOH 50% | 32.96 |
| Nalco DVS3C008 (Phosphinic acid, | 3.41 |
| sodium salt) | |
| Acusol 448 | 8.28 |
| Sodium Aluminate | 0.24 |
| Trilon M Granules (MGDA) | 8.23 |
| Pluronic 25R2 (Defoamer) | 1.04 |
| Tetronic 90R4 | 2.56 |
| Sodium Xylene Sulfonate 40% | 3.12 |
| Sodium Carbonate, anhyd. | 29.83 |
| Glycerol Carbonate | 10.34 |
| Total | 100 |
| % Alkalinity, Na₂O | 28% |

No Reflectance Data available (CIELAB), L*, a*, b*

No L*, a*, b* results were measured for the evaluation of Composition 2 (which were confirmed by visual assessment of ceramic tiles) with level of blueness indicating poor to marginal ADW performance in a 10 Cycle Machine Warewash evaluation.

Additional testing with was conducted using another zero percent caustic bead formulation with alternative chelant and enzyme compositions as shown in Table 4. This formulation included an alkaline cast solid with DTPA and 3% enzyme.

TABLE 4

| Description - Composition 3 | Wt-% |
|---|---|
| NaOH 50% | 20.16 |
| Nalco DVS3C008 (Phosphinic acid, | 3.01 |
| sodium salt) | |
| Acusol 448 | 7.60 |
| Sodium Aluminate 45% | 0.23 |
| Pluronic 25R2 (Defoamer) | 1.00 |
| LD 097 | 2.52 |
| Sodium Xylene Sulfonate 96% | 1.05 |
| DTPA | 3.56 |
| D-sorbitol 70% | 3.02 |
| Sodium Carbonate, anhyd. | 47.06 |
| Glycerol Carbonate | 7.71 |
| Esperase 6.0T | 3.09 |
| Total | 100 |
| % Alkalinity, Na₂O | 33% |

Reflectance (CIELAB), L*, a*, b*
L* = 92.8
a* = −0.2
b* = 2.7

The L*, a*, b* results measured and reported in Table 4 (which were confirmed by visual assessment of ceramic tiles) with ceramic tiles from a duplicate run testing Composition 3 showing improved performance with the DTPA chelant and enzyme.

Additional testing with was conducted using another zero percent caustic bead formulation with alternative chelant and enzyme compositions as shown in Table 5. This formulation included an alkaline cast solid with MGDA and 3% enzyme.

TABLE 5

| Description - Composition 4 | Wt-% |
|---|---|
| NaOH 50% | 20.01 |
| Nalco DVS3C008 (Phosphinic acid, | 3.48 |
| sodium salt) | |
| Acusol 448 | 7.98 |
| Sodium Aluminate 45% | 0.21 |
| Pluronic 25R2 (Defoamer) | 1.04 |
| LD 097 | 2.48 |
| Sodium Xylene Sulfonate 96% | 0.59 |
| MGDA | 5.08 |
| D-sorbitol 70% | 0.52 |
| Sodium Carbonate, anhyd. | 46.63 |
| Glycerol Carbonate | 8.96 |
| Esperase 6.0T | 3.00 |
| Total | 100 |
| % Alkalinity, Na₂O | 34% |

Reflectance (CIELAB), L*, a*, b*
L* = 88.7
a* = −1.0
b* = −2.7

The L*, a*, b* results measured and reported in Table 5 (which were confirmed by visual assessment of ceramic tiles) showing improved protein soil removal in comparison to the caustic bead containing control. The results with Composition 4 (zero percent caustic beads) after a 10-Cycle Machine Warewash experiment show performance, based on protein removal (degree of blueness), is better than a control (caustic beads containing without enzyme).

Additional testing was conducted using another zero percent caustic bead formulation with alternative chelant and enzyme compositions as shown in Table 6. This formulation included an alkaline cast solid with Chelant00929 polymer and 3% enzyme.

TABLE 6

| Description - Composition 5 | Wt-% |
|---|---|
| NaOH 50% | 20.70 |
| Nalco DVS3C008 (Phosphinic acid, | 3.60 |
| sodium salt) | |
| Chelant00929 (85% Acrylic Acid, 10% | 12.40 |
| Maleic Acid, 5% ATBS) | |
| Sodium Aluminate 45% | 0.20 |
| Pluronic 25R2 (Defoamer) | 2.00 |
| Tetronic 90R4 | 2.60 |
| Sodium Xylene Sulfonate 96% | 1.30 |
| Sodium Carbonate, anhyd. | 46.70 |
| Glycerol Carbonate | 7.70 |
| Esperase 6.0T | 1.00 |
| Total | 100 |
| % Alkalinity, Na₂O | 33% |

No Reflectance Data available (CIELAB), L*, a*, b*

Composition 5 containing 25R2, 90R4 and Esperase 6.0T (3%) was evaluated for Protein Removal with reduced enzyme concentration. The protein removal results were poor to fair protein removal, noting that no chelant was used in this formulation. Visual assessment of ceramic tiles confirmed poor removal with remaining dye on the ceramic tiles with the composition that did not include a strong chelant.

Additional testing was conducted using another zero percent caustic bead formulation with alternative chelant and enzyme compositions as shown in Table 7. This formulation included an alkaline cast solid with Chelant00929 and 1% enzyme.

TABLE 7

| Description - Composition 6 | Wt-% |
|---|---|
| NaOH 50% | 20.70 |
| Nalco DVS3C008 (Phosphinic acid, | 3.60 |
| sodium salt) | |
| Chelant00929 (85% Acrylic Acid, 10% | 12.40 |
| Maleic Acid, 5% ATBS) | |
| Sodium Aluminate 45% | 0.20 |
| Pluronic 25R2 (Defoamer) | 2.00 |
| Soft water | 2.10 |
| Tetronic 90R4 | 2.60 |
| Sodium Xylene Sulfonate 96% | 1.00 |
| Sodium Carbonate, anhyd. | 46.70 |
| Glycerol Carbonate | 7.70 |
| Esperase 6.0T | 1.00 |
| Total | 100 |
| % Alkalinity, Na₂O | 33% |

No Reflectance Data available (CIELAB), L*, a*, b*

Composition 6 with Esperase 6.0T without chelant did not show improved protein soil removal in comparison to the control and in comparison to evaluated formulations with a chelant (e.g. DTPA) included.

Additional testing was conducted as a Control comparison using caustic bead and sodium NaOH with a higher alkalinity composition (47% Na₂O) and various chelant, polymer/surfactant compositions as shown in Table 8.

TABLE 8

| Description - Composition 7 | Wt-% |
|---|---|
| NaOH 50% | 17.18 |
| Caustic bead | 54.14 |
| Sodium gluconate | 7.63 |
| Nalco DVS3C008 (Phosphinic acid, | 5.00 |
| sodium salt) | |
| Propoxy-Ethoxy N-3 | 0.75 |
| Sodium Aluminate 45% | 0.21 |
| Hexylene glycol | 0.10 |
| Soft water | 0.50 |
| Acusol 448 | 8.00 |
| Sodium Xylene Sulfonate 96% | 1.00 |
| Sodium sulfate (anhydrous) | 6.49 |
| Total | 100 |
| % Alkalinity, Na₂O | 47% |

Reflectance (CIELAB), L*, a*, b*
L* = 86.075
a* = −0.05
b* = −8.80

The results testing Composition 7 (an Inline Solid Caustic Bead detergent composition) was included as a control. Performance, based on protein removal (degree of blueness) is less than experimental formulations containing enzyme and Chelant. CIELAB values for this control are 86.075, −0.05, −8.8 (L*, a*, b*, respectively).

### Example 2

The solid alkaline composition according to Table 9 was evaluated for enzyme stability in dispensing in light of the favorable protein removal results of similarly evaluated compositions in Example 1. A commercially-available control was used as well to compare the evaluated composition with approximately 40% sodium carbonate to a control formulation with approximately 80% sodium carbonate. The control contained 0.5% enzyme while the Composition 8 contained 2% enzyme; however the testing evaluated percentage of retained activity, which is calculated based on the amount of enzyme in each starting formula such that the difference in enzyme formulation is adjusted for.

TABLE 9

| Description - Composition 8 | Wt-% |
|---|---|
| NaOH 50% | 7.4 |
| MGDA 40% | 12.2 |
| SURFONIC LD-097 | 2.6 |
| Sodium Aluminate 45% | 0.3 |
| Nalco DVS3C008 (Phosphinic acid, | 5.2 |
| sodium salt) | |
| Pluronic 25R2 | <1% |
| Soft water | 14.8 |
| Acusol 448 | 8.00 |
| Sodium Carbonate | 40.6 |
| Glycerol Carbonate | 6.2 |
| Esperase 6.0T | 2.0 |
| Total | 100 |
| % Alkalinity, Na₂O | 21.5 |
| Molar Ratio Water:Carbonate | 4.68:1 |

During dispensing of the solid composition, run off was collected at various points throughout the test. Around 50 grams of dispensed liquid was collected on the initial steady state cycle, and then cycles 50,100,150, 200, 250, and 300. The samples were then kept in a −50 degrees Celsius freezer to preserve the enzyme. The enzyme stability was measured by QA™ 476 (Proteolytic Enzyme Activity by Plate Reader) on each sample and then the enzyme activity could be measured throughout the dispense test to calculate the percentage of retained enzymatic activity.

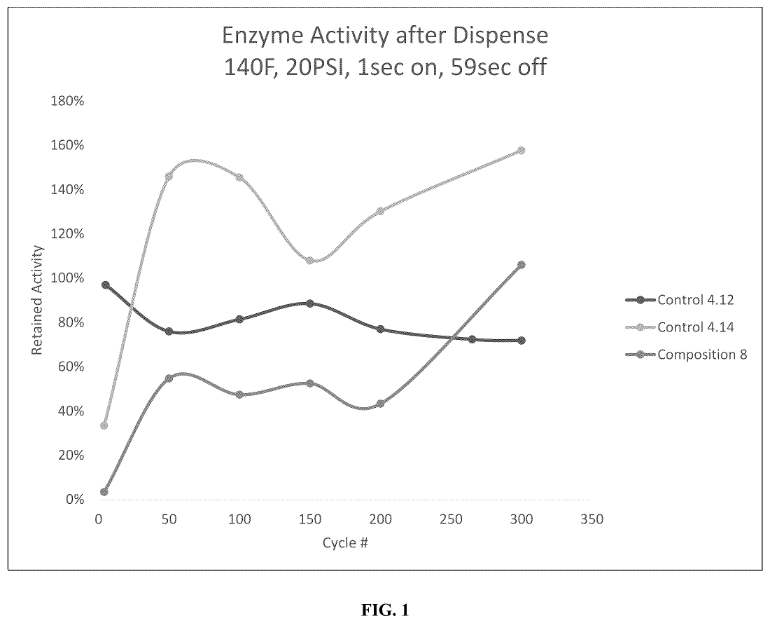

The results are shown in FIG. 1 where showing enzyme activity remains relatively constant throughout the dispense test for both Composition 8 and Controls. A solid sample of the Composition 8 showed 49% enzyme recovery and consistently showed 50% enzyme activity, indicating that although about half the enzyme is denatured in processing the solid, no further degradation occurs during dispensing. Beneficially the results are achieved without inclusion of other conventional enzyme stabilizing agents, e.g. borates. The variability depicted in FIG. 1 between the cycles is impacted by homogeneity of solid compositions as evaluated. This is depicted from the comparison of the Control (using two different blocks of the same composition and showing variation). The retained activity is based on what an expected concentration, as a result % in excess of 100% show variation in the run off collected from a particular cycle and does not indicate gained enzymatic activity relative to the amount in the solid composition.

### Example 3

The enzyme stability is further confirmed through performance testing for protein removal. The Composition 8 was further compared to the Control according to the methods of Example 1 wherein the Control is a substantially higher alkalinity detergent without enzyme.

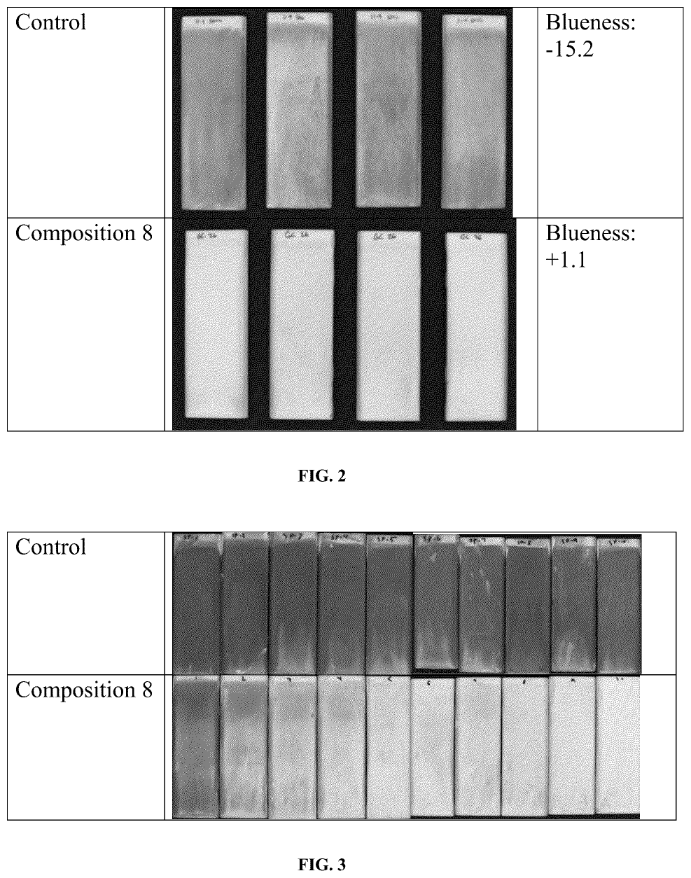

The results are shown in FIG. 2 showing excellent performance in removing protein soils and under processing conditions with 5 grain water.

The results are further shown in FIG. 3 where caked on soils were evaluated for removal after the same 10-cycle testing methods, again showing significant improvement by Composition 8.

### Example 4

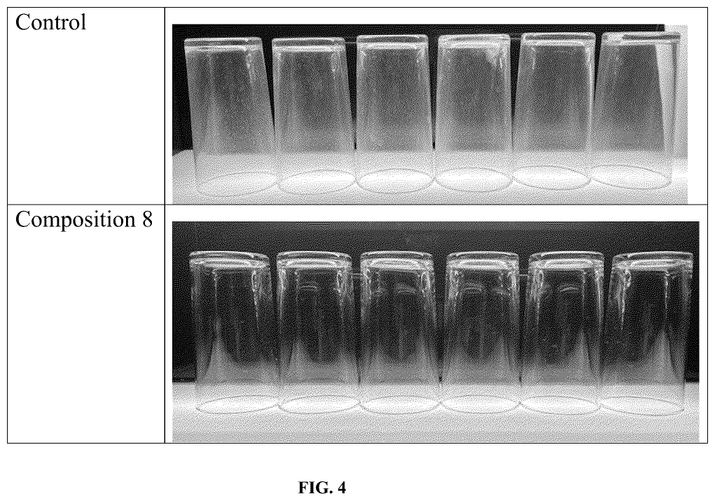

A 50-cycle test was run on glassware to evaluate and compare performance of Composition 8 was to the Control for protein redeposition. The results are shown in FIG. 4 where Composition 8 again outperformed the Control and demonstrating both enzyme stability and the improved performance with the solid compositions including surfactant, enzyme and chelant with the alkalinity sources.

### Example 5

Additional testing was repeated according to the method in Example 2 for further confirmation of enzyme stability throughout the multicycle dispensing of a solid composition. The same solid alkaline composition according to Table 9 (Composition 8) was evaluated for enzyme stability in dispensing with modification to the method and cycles where runoff was collected as described further herein.

During dispensing of the solid composition, run off was collected at various points throughout the test. Around 50 grams of dispensed liquid was collected on the initial steady state cycle, and then cycles before 50, multiple cycles before 100, approximately 175, and again between 200 and 250.

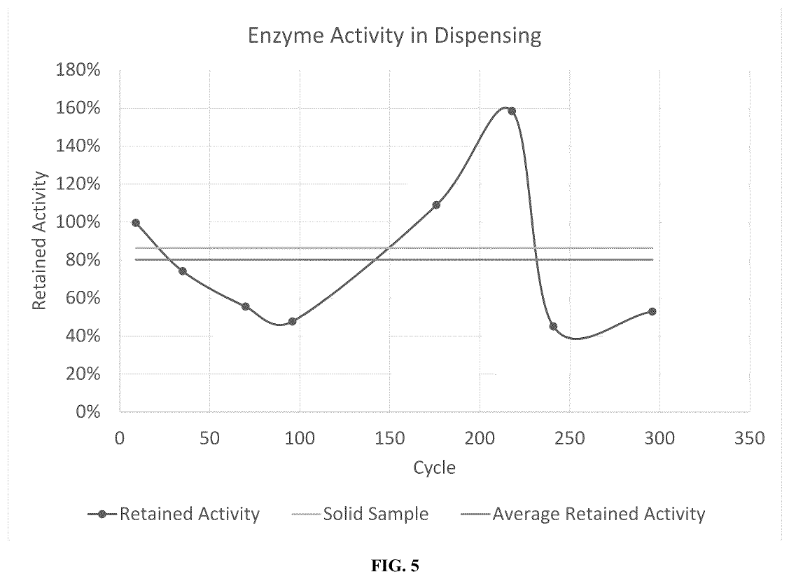

The results are shown in FIG. 5 where showing enzyme activity remains relatively constant throughout the dispense test for Composition 8. A solid sample of the Composition 8 confirmed that 86% of the enzyme survived the production process. The retained activity was variable while maintaining high recovery. Again it is noted that the variability is likely due homogeneity of solid compositions as evaluated. The retained activity is based on what an expected concentration, as a result % in excess of 100% show variation in the run off collected from a particular cycle and does not indicate gained enzymatic activity relative to the amount in the solid composition.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized, and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A composition comprising:
alkalinity source comprising an alkali metal hydroxide, alkali metal carbonate and/or reagents comprising an organic molecule having at least one hydroxyl group or an alkylene carbonate;
a first surfactant comprising a first reverse EO/PO block copolymer of about 10-40% EO;
an optional second surfactant comprising at least one of a second reverse EO/PO block copolymer of about 40-50% EO, an alkyl capped alcohol ethoxylate, a capped block copolymer, and alkyl pyrrolidone;
a strong chelating agent having a stability constant with calcium that is at least about 1×10⁷; and
a protease enzyme,
wherein the composition is a liquid or solid and has between from about 20-47% total alkalinity as measured by percent Na₂O in the composition.

2. The composition of claim 1, wherein the first reverse EO/PO block copolymer is about 20% EO and the second reverse EO/PO block copolymer is about 40% EO.

3. The composition of claim 1, wherein the first surfactant comprises from about 0.1 wt-% to about 5 wt-% of the composition and/or wherein the second surfactant(s) comprises from about 0.1 wt-% to about 20 wt-% of the composition.

4. The composition of claim 1, wherein the second surfactant is the alkyl capped alcohol ethoxylate having the structure: R₁—O—(CH₂CH₂O)ₙ—R₂ where R₁ is a linear or branched (C₁₀-C₁₈) alkyl group, R₂ is C₁-C₄, and n is an integer in the range of 1 to 100, or wherein the alkyl capped alcohol ethoxylate is a butyl capped alcohol ethoxylate.

5. The composition of claim 1, wherein the second surfactant is the alkyl pyrrolidone is C8 or C10 alkyl pyrrolidone.

6. The composition of claim 1, wherein the chelant is selected from the group consisting of NTA, EDTA, DTPA TTHA, MGDA, GLDA, and a ternary polymer comprising acrylic acid/maleic acid/ATBS.

7. The composition of claim 1, wherein the protease enzyme is Esperase 6.0T.

8. The composition of claim 1, further comprising a hydrotrope and/or water conditioning polymer.

9. The composition of claim 1, wherein the alkalinity source comprises alkali metal carbonate and/or alkali metal hydroxide, and wherein the wt-% of the alkali metal carbonate exceeds the wt-% of the alkali metal hydroxide.

10. The composition of claim 9, further comprising an alkylene carbonate that is glycerin carbonate, ethylene carbonate, propylene carbonate, or butylene carbonate, and wherein the molar ratio of the initial alkali metal hydroxide to alkylene carbonate combined to make the solid composition is from about 0.5:1 to about 10:1.

11. The composition of claim 1, wherein the composition is free of solid alkali metal hydroxide beads, or wherein the composition has at least about 50% less solid alkali metal hydroxide beads compared to a caustic beads containing solid composition that does not contain a polyol or the alkylene carbonate forming the solid composition.

12. The composition of claim 1, wherein the alkalinity source comprises a polyol comprising glycol, glycerin or sorbitol and alkali metal hydroxide, and wherein the weight ratio of the alkali metal hydroxide to water in the solid composition is from about 27:73 to about 75:25.

13. The composition of claim 12, further comprising water, and wherein the wherein the molar ratio of alkali metal hydroxide to water in the solid is about 1:2.2 to about 1:1.

14. The composition of claim 1, wherein the solid composition is formed in-situ and/or wherein the solid composition is contiguous solid that is a pressed, cast, or extruded solid, powder or granule.

15. The composition of claim 14, wherein the solid composition is a multi-use composition and the protease enzymes is stabilized therein as measured by enzyme surviving the multi-use dispensing.

16. The composition of claim 1, wherein alkalinity source(s) comprises from about 20 wt-% to about 80 wt-%, the chelant comprises from about 2 wt-% to about 15 wt-%, the enzyme comprises from about 1 wt-% to about 5 wt-%, and wherein the first surfactant comprising the reverse EO/PO block copolymer having 10-40% EO comprises from about 0.1 wt-% to about 5 wt-%, and wherein the second surfactant(s) comprise from about 0.1 wt-% to about 20 wt-% of the composition.

17. A method of use comprising:
generating a use solution of the composition according to claim 1;
contacting an article or surface in need of soil removal with the use solution; and
cleaning to remove the soil from the article or surface, wherein the soil comprises protein.

18. The method of claim 17, wherein the use solution is between about 50 ppm to about 5,000 ppm of the solid composition, and/or wherein the step of generating a use solution is by diluting a multi-use solid composition and wherein the protease enzyme survives the multi-use dispensing.

19. The method of claim 17, wherein the use solution is applied in a ware washing machine and optionally the use solution is contact with the articles of ware therein at a temperature range of about 120-180° F., or wherein the use solution is applied in a laundry or textile care washing machine.

20. The method of claim 17, wherein the surface is a hard surface, instrument or ware.
